(19) United States
(12) Patent Application Publication
(10) Pub. No.: US 2021/0215803 A1
(43) Pub. Date: Jul. 15, 2021

(54) SCANNING MODULE, DISTANCE MEASURING DEVICE, DISTANCE MEASURING ASSEMBLY, DISTANCE DETECTION DEVICE, AND MOBILE PLATFORM

(71) Applicant: SZ DJI TECHNOLOGY CO., LTD., Shenzhen (CN)

(72) Inventors: Likui ZHOU, Shenzhen (CN); Huai HUANG, Shenzhen (CN); Jing ZHAO, Shenzhen (CN); Xiaoping HONG, Shenzhen (CN); Zongcai XU, Shenzhen (CN); Peng WANG, Shenzhen (CN); Wanqi LIU, Shenzhen (CN)

(21) Appl. No.: 17/214,798

(22) Filed: Mar. 26, 2021

Related U.S. Application Data
(63) Continuation of application No. PCT/CN2018/108500, filed on Sep. 28, 2018.

(51) Int. Cl. G01S 7/481; G01S 17/42; G01S 7/484; G01S 7/4861

(52) U.S. Cl. CPC G01S 7/4817; G01S 7/4861; G01S 7/484; G01S 17/42

(57) ABSTRACT

The present disclosure provides a distance detection device. The distance detection device includes a housing; and a plurality of distance measuring assemblies disposed in the housing. Two adjacent distance measuring assemblies have overlap field of views. Each distance measuring assembly is configured to measure a distance from an object to be detected in the corresponding field of view to the distance detection device.

### CROSS-REFERENCE TO RELATED APPLICATION

This application is a continuation of International Application No. PCT/CN2018/108500, filed on Sep. 28, 2018, the entire content of which is incorporated herein by reference.

### TECHNICAL FIELD

The present disclosure relates to the technical field of laser distance measuring and, more specifically, to a scanning module, a distance measuring device, a distance measuring assembly, a distance detection device, and a mobile platform.

### BACKGROUND

To improve the utilization efficiency of laser emitting and receiving element conditions and realize high-density and high-resolution three-dimensional (3D) spatial scanning and distance measuring, the mechanical distance measuring device needs a high-speed motor to deflect and scan an optical path. The high-speed motor causes greater vibration of the distance measuring device, thereby reducing the accuracy of the distance measuring device.

### SUMMARY

One aspect of the present disclosure provides a distance detection device. The distance detection device includes a housing; and a plurality of distance measuring assemblies disposed in the housing. Two adjacent distance measuring assemblies have overlap field of views. Each distance measuring assembly is configured to measure a distance from an object to be detected in the corresponding field of view to the distance detection device.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic diagram of a 3D structure of a distance detection device according to some embodiments of the present disclosure.

FIG. 2 is a schematic diagram of the 3D structure of the distance detection device according to some embodiments of the present disclosure form another perspective.

FIG. 3 is a partial 3D exploded schematic diagram of the distance detection device according to some embodiments of the present disclosure.

FIG. 4 is a partial 3D exploded schematic diagram of the distance detection device according to some embodiments of the present disclosure.

FIG. 5 is a partial 3D exploded schematic diagram of the distance detection device according to some embodiments of the present disclosure form another perspective.

FIG. 6 is a schematic diagram of a 3D structure of a distance measuring assembly of the distance detection device according to some embodiments of the present disclosure.

FIG. 7 is a schematic cross-sectional view of the distance measuring assembly in FIG. 6.

FIG. 8 is a schematic diagram of a partial 3D structure of the distance detection device according to some embodiments of the present disclosure.

FIG. 9 is a partial 3D exploded schematic diagram of the distance detection device in FIG. 8.

FIG. 10 is a schematic cross-sectional view of the distance detection device in FIG. 8 along a line X-X.

FIG. 11A is a schematic diagram of a distance measuring principle of the distance measuring assembly of the distance measuring device according to some embodiments of the present disclosure.

FIG. 11B is a schematic diagram of a module of the distance measuring assembly of the distance measuring device according to some embodiments of the present disclosure.

FIG. 12 is a schematic diagram of the distance measuring principle of the distance measuring assembly of the distance measuring device according to some embodiments of the present disclosure.

FIG. 13 is a schematic cross-sectional view of the distance detection device in FIG. 1 along a line XIII-XIII.

FIG. 14 is an enlarged schematic diagram of the distance detection device at a point XIV in FIG. 13.

FIG. 15 is a 3D exploded schematic diagram of a flexible connection assembly of the distance detection device according to some embodiments of the present disclosure.

FIG. 16 is a schematic cross-sectional view of the distance detection device in FIG. 1 along a line XVI-XVI.

FIG. 17 is a schematic diagram of a 3D structure of a first electrical connector of the distance detection device according to some embodiments of the present disclosure.

FIG. 18 is a schematic diagram of a 3D structure of a second electrical connector of the distance detection device according to some embodiments of the present disclosure.

FIG. 19 is a schematic diagram of a 3D structure of a cover and a protective cover of the distance detection device according to some embodiments of the present disclosure.

FIG. 20 is a schematic diagram of a 3D structure of the distance detection device according to some embodiments of the present disclosure.

FIG. 21 is a schematic diagram of a 3D structure of the distance detection device according to some embodiments of the present disclosure from another perspective.

FIG. 22 to FIG. 24 are partial 3D exploded schematic diagrams of the distance detection device according to some embodiments of the present disclosure.

FIG. 25 is a schematic cross-sectional view of the distance detection device in FIG. 20 along a line XXV-XXV.

FIG. 26 is a schematic structural diagram of a mobile platform according to some embodiments of the present disclosure.

### DETAILED DESCRIPTION OF THE EMBODIMENTS

Reference will now be made in detail to exemplary embodiments, examples of which are illustrated in the accompanying drawings, in which the same or similar reference numbers throughout the drawings represent the same or similar elements or elements having same or similar functions. Embodiments described below with reference to drawings are merely exemplary and used for explaining the present disclosure, and should not be understood as limitation to the present disclosure.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom”, “inner”, “outer”, “clockwise”, “anticlockwise” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements or interactions of two elements, which can be understood by those skilled in the art according to specific situations.

In the description of the present disclosure, a structure in which a first feature is “on” a second feature may include an embodiment in which the first feature directly contacts the second feature, and may also include an embodiment in which an additional feature is formed between the first feature and the second feature so that the first feature does not directly contact the second feature, unless otherwise specified. Furthermore, a first feature “on,” “above,” or “on top of” a second feature may include an embodiment in which the first feature is right “on,” “above,” or “on top of” the second feature, and may also include an embodiment in which the first feature is not right “on,” “above,” or “on top of” the second feature, or just means that the first feature has a sea level elevation larger than the sea level elevation of the second feature. While first feature “beneath,” “below,” or “on bottom of” a second feature may include an embodiment in which the first feature is right “beneath,” “below,” or “on bottom of” the second feature, and may also include an embodiment in which the first feature is not right “beneath,” “below,” or “on bottom of” the second feature, or just means that the first feature has a sea level elevation smaller than the sea level elevation of the second feature.

Various embodiments and examples are provided in the following description to implement different structures of the present disclosure. In order to simplify the present disclosure, certain elements and settings will be described. However, these elements and settings are only examples and are not intended to limit the present disclosure. In addition, reference numerals may be repeated in different examples in the disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

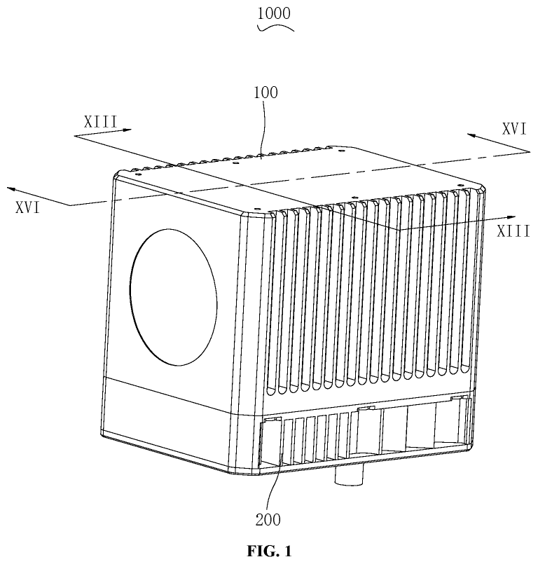

Referring to FIG. 1, an embodiment of the present disclosure provides a distance detection device 1000, the distance detection device 1000 can be used to measure the distance between an object to be detected and the distance detection device 1000, and the orientation of the object to be detected relative to the distance detection device 1000. In some embodiments, the distance detection device 1000 may include a radar, such as a lidar. In some embodiments, the distance detection device 1000 may be used to detect external environment information, such as distance information, orientation information, reflection intensity information, speed information, etc. of targets in the environment. In some embodiments, the distance detection device 1000 may detect the distance between an object to be detected and the distance measuring device by measuring the time of light propagation between the distance measuring device and the object to be detected, that is, the time-of-flight (TOF). Alternatively, the distance detection device 1000 may also detect the distance between the object to be detected and the distance detection device 1000 through other technologies, such as a distance measuring method based on phase shift measurement or a distance measuring method based on frequency shift measurement, which is not limited in the embodiments of the present disclosure. In some embodiments, the distance and orientation detected by the distance detection device 1000 can be used for remote sensing, obstacle avoidance, surveying and mapping, modeling, navigation, and the like.

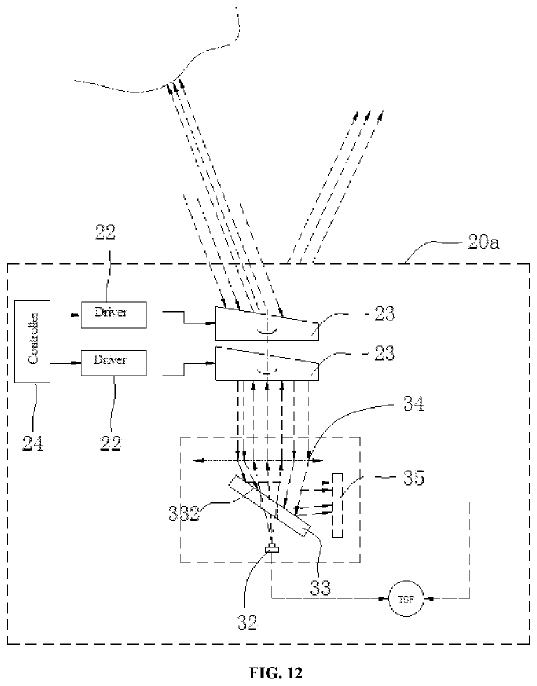

For ease of understanding, the working process of distance measurement will be described by an example in conjunction with the distance detection device 1000 shown in FIG. 11B.

As shown in FIG. 11B, the distance detection device 1000 includes a transmitting circuit 320, a receiving circuit 351, a sampling circuit 352, and an arithmetic circuit 353.

The transmitting circuit 320 may emit a light pulse sequence (e.g., a laser pulse sequence). The receiving circuit 351 may receive the light pulse sequence reflected by the object to be detected, and perform photoelectric conversion on the light pulse sequence to obtain an electrical signal. After the electrical signal is processed, it may be output to the sampling circuit 352. The sampling circuit 352 may sample the electrical signal to obtain a sampling result. The arithmetic circuit 353 may determine the distance between the distance detection device 1000 and the object to be detected based on the sampling result of the sampling circuit 352.

In some embodiments, the distance detection device 1000 may also include a control circuit 354, the control circuit 354 may be used to control other circuits. For example, the control circuit 354 may control the working time of each circuit and/or set the parameters of each circuit.

It can be understood that although the distance detection device 1000 shown in FIG. 11B includes a transmitting circuit 320, a receiving circuit 351, a sampling circuit 352, and an arithmetic circuit 353, the embodiments of the present disclosure are not limited thereto. The number of any one of the transmitting circuit 320, the receiving circuit 351, the sampling circuit 352, and the arithmetic circuit 353 may also be two or more.

An implementation of the circuit frame of the distance detection device 1000 has been described above, and some examples of the structure of the distance detection device 1000 will be described below in conjunction with various drawings.

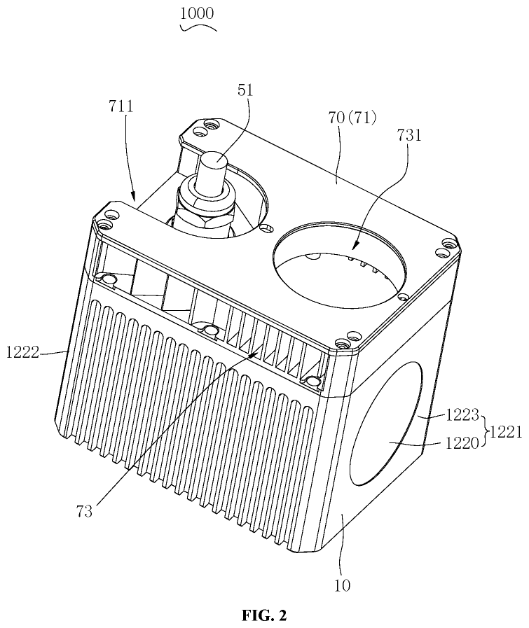

Referring to FIG. 1, the distance detection device 1000 includes a distance measuring device 100 and a heat dissipation structure 200. Referring to FIG. 2 to FIG. 4, the distance measuring device 100 includes a housing 10, a scanning module 20, and a distance measuring module 30. The scanning module 20 and the distance measuring module 30 are positioned in the housing 10. The distance measuring module 30 can be configured to emit laser pulses to the scanning module 20, and the scanning module 20 can be configured to change the transmission direction of the laser pulses and then emit them. The laser pulses reflected by the object to be detected can incident on the distance measuring module 30 after passing through the scanning module 20. The distance measuring module 30 can be configured to determine the distance between the object to be detected and the distance detection device 1000 based on the reflected laser pulses. In one example, the circuit described in FIG. 11B above may be all positioned in the distance measuring module 30.

In one example, the heat dissipation structure 200 may include a baffle assembly 70 and a fan 80. The baffle assembly 70 and the fan 80 can be disposed on the housing 10, and the baffle assembly 70 and the housing 10 together can form a heat dissipation air duct 73. The heat dissipation structure 200 may be formed with an air inlet 731 and an air outlet 732 connected to the heat dissipation air duct 73 and the outside of the distance detection device 1000. The fan 80 may be disposed in the heat dissipation air duct 73 and positioned at the air inlet 731 and/or the air outlet 732.

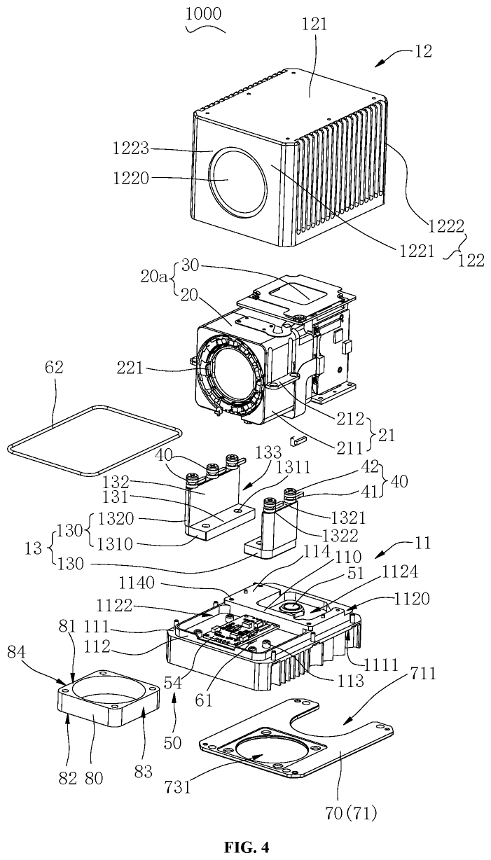

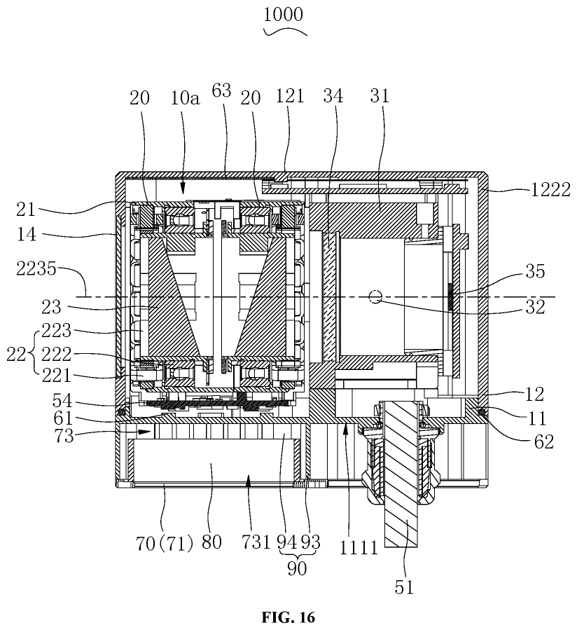

In one example, referring to FIG. 2 and FIG. 4, the distance measuring device 100 includes a housing 10, a distance measuring assembly 20a, and one or more of a flexible connection assembly 40, a circuit board assembly 50, a heat conducing element 61, a sealing member 62, or a sound absorbing member 63 (shown in FIG. 16).

The housing 10 may be made of a thermally conductive material. For example, the housing 10 may be made of a thermally conductive material such as copper of aluminum, or the housing 10 may be made of a thermally conductive non-metallic material such as thermally conductive plastic. Referring to FIG. 16, the housing 10 is formed with a receiving cavity 10a. The distance measuring assembly 20a, the flexible connection assembly 40, the circuit board assembly 50, the heat conducing element 61, the sealing member 62, and the sound absorbing member 63 are disposed in the receiving cavity 10a. In one example, the housing 10 may include a base 11, and a cover 12 that can be combined with the base 11 to form the receiving cavity 10a. In one example, the housing 10 may further include a mounting seat 13, and the mounting seat 13 may be disposed in the receiving cavity 10a. In some embodiments, the base 11 and the mounting seat 13 may be integrally formed, or the base 11 and the mounting seat 13 may also be two independent components, which are fixed to each other by bonding or some fixing structure.

In one example, referring to FIG. 4, the base 11 includes a bottom plate 111, an annular limiting wall 112, a positioning column 113, and a mounting protrusion 114.

The bottom plate 111 may have a plate-like structure. In some embodiments, the bottom plate 111 may have a rectangular plate structure, a pentagonal plate structure, or a hexagonal plate structure. The bottom plate 111 may include a base bottom surface 1111.

The annular limiting wall 112 may be formed by extending from the side of the bottom plate 111 opposite to the base bottom surface 1111. The annular limiting wall 112 of this embodiment is disposed around the center of the bottom plate 111. More specifically, the annular limiting wall 112 is disposed on the bottom plate 111 at a position close to the edge of the bottom plate 111, and there is a certain distance between the annular limiting wall 112 and the edge of the bottom plate 111. The annular space enclosed by the annular limiting wall 112 and the bottom plate 111 is partitioned by an intermediate wall 110 into an installation space 1122 and a receiving space 1124.

The positioning column 113 may be formed to protrude from the side of the bottom plate 111 opposite to the base bottom surface 1111. There may be a plurality of positioning columns 113, and the plurality of positioning columns 113 may be disposed in the installation space 1122 at intervals. That is, the annular limiting wall 112 can surround a plurality of positioning columns 113.

The mounting protrusion 114 can be formed by extending from a top 1120 of the annular limiting wall 112 toward a direction away from the bottom plate 111. A plurality of protrusion coupling holes 1140 can be disposed on the mounting protrusion 114.

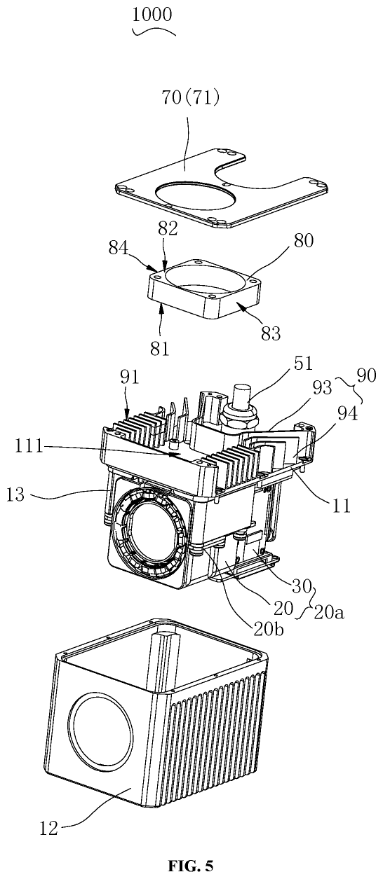

Referring to FIG. 4 and FIG. 5, the cover 12 is disposed on the base 11, and the cover 12 includes a cover top wall 121 and an annular cover side wall 122.

The cover top wall 121 may have a plate-like structure, and the shape of the cover top wall 121 may match the shape of the bottom plate 111. In this embodiment, the bottom plate 111 has a rectangular plate-shaped structure, and the cover top wall 121 of the cover also has a rectangular plate-shaped structure.

The annular cover side wall 122 may extend from a surface of the cover top wall 121, and the annular cover side wall 122 may be disposed on the edge of the cover top wall 121 and surround the cover top wall 121. The annular cover side wall 122 may be mounted on the bottom plate 111 and surround the annular limiting wall 112 by any one or more methods such as screw connection, clamping, gluing, or welding. The annular cover side wall 122 may include a first cover side wall 1221 and a second cover side wall 1222. The first cover side wall 1221 and the second cover side wall 1222 may be positioned at opposite ends of the cover top wall 121. The first cover side wall 1221 may be formed with a light-transmitting area 1220. The area of the first cover side wall 1221 other than the light-transmitting area 1220 may be a non-light-transmissive area 1223, and the light-transmitting area 1220 may be used for the distance measurement signal sent by the distance measuring device 100 to pass through. The light-transmitting area 1220 may be made of plastic, resin, glass, and other material with high light transmittance, while the non-light-transmissive area 1223 may be made of copper, aluminum, and other metals that conduct heat and have low light transmittance. In some embodiments, the light-transmitting area 1220 may be made of thermally conductive plastic, which not only satisfies the light transmission needs, but also meets the heat dissipation needs.

Referring to FIG. 4, the mounting seat 13 is mounted on the bottom plate 111 and positioned in the top 1120. More specifically, the mounting seat 13 includes a mounting plate 131 and a mounting arm 132. In some embodiments, the mounting plate 131 may be an integrated structure, and the mounting arm 132 may also be an integrated structure. In some embodiments, the mounting plate 131 may be an integrated structure, the mounting arm 132 may be a split structure including a plurality of sub-mounting arms 1320, and two or more sub-mounting arms 1320 may be oppositely disposed. In some embodiments, the mounting plate 131 may be a split structure including a plurality of sub-mounting plates 1310. In some embodiments, the mounting plate 131 may be a split structure including a plurality of sub-mounting plates 1310, the mounting arm 132 may be a split structure including a plurality of sub-mounting arms 1320, and two or more sub-mounting arms 1320 may be oppositely disposed.

In the following description, the mounting plate 131 is taken as an integrated structure and the mounting arm 132 is also take as an integrated structure as an example. The mounting plate 131 may have a plate-like structure. A plurality of mounting plate positioning holes 1311 may be disposed on the mounting plate 131. The mounting plate 131 may be mounted on the bottom plate 111 and the positioning columns 113 may be inserted into the mounting plate positioning holes 1311. The mounting plate 131 may be combined with the positioning column 113 by a locking member (not shown in the accompanying drawings) to fix the mounting plate 131 on the base 11. The positioning column 113 of this embodiment may include a threaded hole, and the locking member may be a screw. The screw may be inserted into the mounting plate positioning holes 1311 and combined with the threaded hole to fix the mounting plate 131 on the base 11. The mounting arm 132 may be formed by extending from the mounting plate 131. The mounting arm 132 may have an annular structure (including a square ring and a circular ring). The end of the mounting arm 132 away from the mounting plate 131 may be a top end 1321. A plurality of mounting arm coupling holes 1322 may be disposed on the top end 1321, and the mounting arm coupling holes 1322 may extend toward the side of the mounting plate 131. The mounting arm 132 and the mounting plate 131 may jointly define a mounting groove 133.

In the following description, the mounting arm 132 is taken as a split structure including a plurality of sub-mounting arms 1320 as an example, and two or more sub-mounting arms 1320 maybe oppositely disposed. In this embodiment, the mounting seat 13 may include two sub-mounting bases 130, the mounting plate 131 may include two sub-mounting plates 1310, and the mounting arm 132 may include two sub-mounting arms 1320. Each sub-mounting bases 130 may include a sub-mounting plate 1310 and a sub-mounting arm 1320. The sub-mounting bases 130 may be in an “L” shape, and the sub-mounting arm 1320 may be formed by extending from the sub-mounting plate 1310. In this embodiment, the two sub-mounting bases 130 may be spaced apart and disposed opposite to each other, the two sub-mounting plates 1310 of the two sub-mounting bases 130 may be spaced apart and disposed opposite to each other, the two sub-mounting arms 1320 of the sub-mounting bases 130 may be space apart and disposed opposite to each other, and the two sub-mounting bases 130 may enclose the mounting groove 133. More specifically, the two sub-mounting plates 1310 and the two sub-mounting arms 1320 may jointly enclose the mounting groove 133. Each sub-mounting plate 1310 may include a mounting plate positioning hole 1311. Each sub-mounting plate 1310 may be inserted into the mounting plate positioning hole 1311 through the positioning column 113, and then combined with the positioning column 113 through a locking member (not shown in accompanying drawings) to fix the sub-mounting plate 1310 on the base 11.

Two example are provided above to describe the structure of the mounting seat 13, and the mounting seat 13 of other structures can be designed based on these two examples, which will not be repeated here.

The distance measuring assembly 20a may be received in the receiving cavity 10a. More specifically, the distance measuring assembly 20a may include a scanning module 20 and a distance measuring module 30. That is, the scanning module 20 and the distance measuring module 30 may be both disposed in the receiving cavity 10a, the at the same time, the scanning module 20 and the distance measuring module 30 may be disposed on the base 11. In some embodiments, the distance measuring module 30 may be used to emit laser pulses to the scanning module 20, and the scanning module 20 may be used to change the transmission direction of the laser pulses and then emit them. The laser pulses reflected by the object to be detected may pass through the scanning module 20 and enter the distance measuring module 30. The distance measuring module 30 may be used to determine the distance between the object to be detected and the distance detection device 1000 based on the reflected laser pulses.

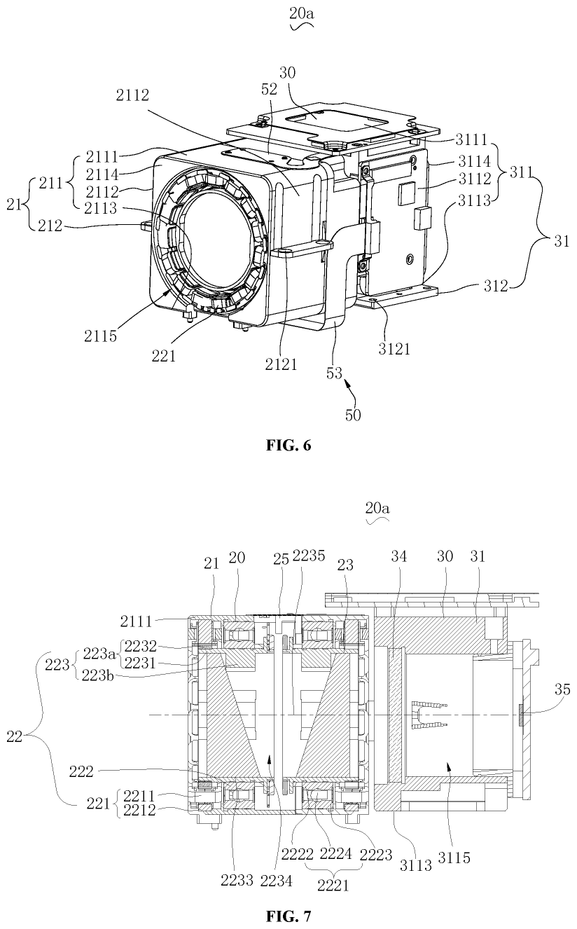

Referring to FIG. 4 and FIG. 5, the scanning module 20 is disposed on the side of the base 11 close to the first cover side wall 1221, and there is at least one joint 20b between the scanning module 20 and the housing 10. Further, the scanning module 20 is mounted on the mounting seat 13, and there are at least two joints 20b between the scanning module 20 and the mounting seat 13. Referring to FIG. 6 and FIG. 7, more specifically, the scanning module 20 includes a scanning housing 21, a driver 22, and optical element 23, a controller 24 (as shown in FIG. 11), and a detector 25. In some embodiments, the driver 22 may be used to drive the optical element 23 to move to change the transmission direction of the laser light passing through the optical element 23. In some embodiments, the optical element 23 may be a lens, a mirror, a prism, a grating, an optical phased array, or any combination of the above optical elements. The driver 22 may drive the optical element 23 to rotate, vibrate, move cyclically along a predetermined path, or move back and forth along a predetermined path, which is not limited in the embodiments of the present disclosure. The following takes the optical element 23 including a prism as an example for description.

Referring to FIG. 6, the scanning housing 21 includes a housing body 211 and two flanges 212. The housing body 211 includes a scanning housing top wall 2111, two scanning housing side walls 2112, a scanning housing bottom wall 2113, and two scanning housing end walls 2114. The scanning housing top wall 2111 and the scanning housing bottom wall 2113 are positioned on opposite sides of the housing body 211, and the two scanning housing side walls 2112 are respectively positioned on opposite sides of the housing body 211 and are connected to the scanning housing top wall 2111 and the scanning housing bottom wall 2113. The scanning housing end walls 2114 are positioned on opposite sides of the housing body 211 and are connected to the scanning housing top wall 2111, the scanning housing bottom wall 2113, and the two scanning housing side walls 2112. The scanning housing top wall 2111 further includes a scanning housing cavity 2115 penetrating through the two scanning housing end walls 2114. The scanning housing cavity 2115 has a circular shape. Referring to FIG. 4, when the mounting plate 131 is an integrated structure and the mounting arm 132 is also an integrated structure, the mounting arm 132 can be opposed to the two scanning housing side walls 2112 of the scanning housing 21. When the mounting plate 131 is a split structure including a plurality of sub-mounting plates 1310 and the mounting arm 132 is an integrated structure, the mounting arm 132 can also be opposed to the two scanning housing side walls 2112 of the scanning housing 21.

The two flanges 212 respectively extend from the two scanning housing side walls 2112 in a direction away from the scanning housing cavity 2115, and both flanges 212 are positioned between the scanning housing side walls 2112 and the scanning housing bottom wall 2113. A plurality of flange mounting holes 2121 may be disposed on the flange 212, and the plurality of flange mounting holes 2121 may correspond to the plurality of mounting arm coupling holes 1322. More specifically, the number, size, and position of the flange mounting holes 2121 may correspond to the number, size, and position of the mounting arm coupling holes 1322.

Referring to FIG. 6 and FIG. 7, the driver 22 is mounted in the scanning housing cavity 2115, and the driver 22 includes a stator assembly 221, a positioning assembly 222, and a rotor assembly 223. The stator assembly 221, the positioning assembly 222, and the rotor assembly 223 are disposed in the scanning housing 21.

The stator assembly 221 can be used to drive the rotor assembly 223 to rotate. The stator assembly 221 includes a winding body 2211, and a winding 2212 mounted on the winding body 2211. The stator assembly 221 may be a stator core, and the winding 2212 may be a coil. The winding 2212 can generate a specific magnetic field under the action of current, and the direction and intensity of the magnetic field can be changed by changing the direction and intensity of the current. The stator assembly 221 may be mounted on the housing body 211 and received in the scanning housing cavity 2115. In this embodiment, the winding 2212 is positioned at a position of the scanning housing cavity 2115 close to an end wall 1514 of the scanning housing.

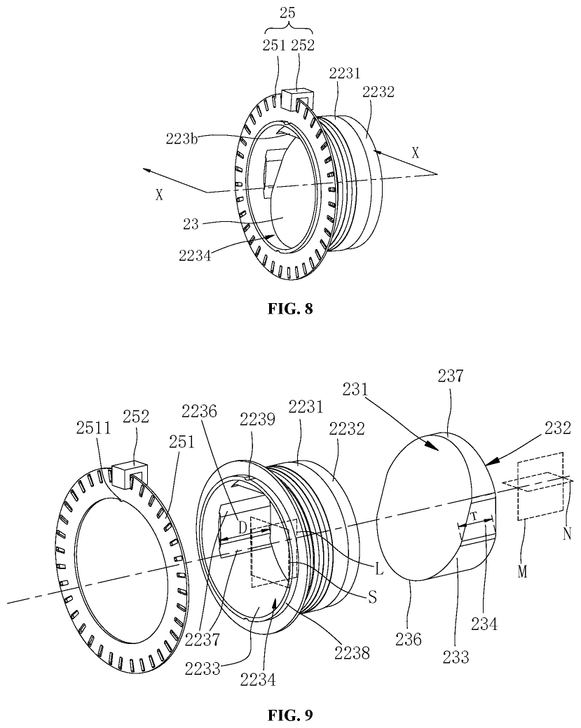

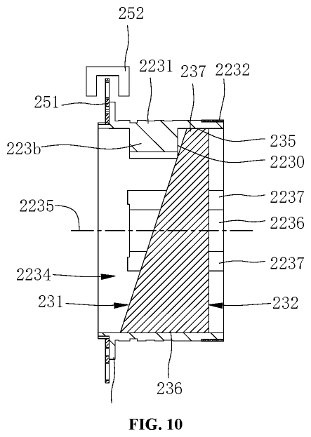

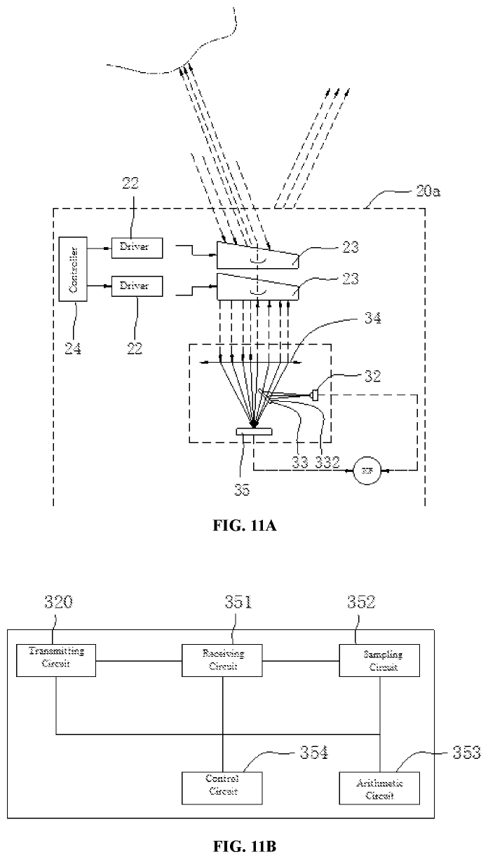

Referring to FIG. 8 to FIG. 10, the rotor assembly 223 may be rotated by the drive of the stator assembly 221.

A prism (or a wedge prism) of the conventional light emitting device can be installed in a lens barrel, and rotating the lens barrel can drive the prism to rotate, and the rotating prism can be used to adjust the exit angle of the light. However, due to the uneven weight distribution of the prism itself, when the prism is rotated at a high speed, the entire lens barrel may be easily shaken and not stable enough. In some implementations of the embodiments of the present disclosure, a boss is provided on the inner wall of the rotor assembly to improve the dynamic balance of the rotor, and the blocking of the light beam passing through the prism by the boss can be reduced. Specific examples will be described below.

The rotor assembly 223 may include a rotor 223a and a boss 223b. The rotor assembly 223 can rotate relative to the stator assembly 221. More specifically, both the rotor 223a and the boss 223b can rotate relative to the positioning assembly 222, and the axis of rotation of the rotor 223a and the boss 223b may be referred to as a rotating shaft 2235. It can be understood that the rotating shaft 2235 may be a physical rotating shaft 2235 or a virtual rotating shaft 2235. At least two joints 20b can be evenly distributed on the periphery of the rotor 223a, such that the vibration generated when the rotor 223a rotates can be evenly transmitted to the housing 10 (and the mounting seat 13) to reduce the shaking of the distance measuring module 30 relative to the mounting seat 13. Further, the positions of the two joints 20b may be symmetrically arranged with respect to the rotation axis of the rotor 223a. Furthermore, the at least two joints 20b may be respectively positioned on at least one circle centered on the rotating shaft 2235 of the rotor 223a and perpendicular to the rotating shaft 2235. In some embodiments, the joint 20b positioned on each circumference may be evenly distributed on the circumference.

The rotor 223a may include a yoke 2231 and a magnet 2232. The magnet 2232 may be sleeved on the yoke 2231 and positioned between the yoke 2231 and the winding 2212. The magnetic field generated by the magnet 2232 may interact with the magnetic field generated by the winding 2212 and generate a force. Since the winding 2212 is fixed, the magnet 2232 can drive the yoke 2231 to rotate under the force. The rotor 223a may have a hollow shape, and the hollow part of the rotor 223a may be formed with a receiving cavity 2234, and the laser pulse can pass through the receiving cavity 2234 and pass through the scanning module 20. Specifically, the receiving cavity 2234 may be enclosed by an inner wall 2233 of the rotor 223a. More specifically, in this embodiment, the yoke 2231 may be in the shape of a hollow cylinder, the hollow part of the yoke 2231 can form a receiving cavity 2234, and the inner wall of the receiving cavity 2234 can be used as an inner wall 2233 enclosing the receiving cavity 2234. Of course, in other embodiments, the receiving cavity 2234 may not be formed on the yoke 2231, but may also be formed on structures such as the magnet 2232, and the inner wall 2233 may also be the inner wall of the structure such as the magnet 2232, which is not limited in the embodiments of the present disclosure. The inner wall 2233 may have a ring structure or may be a part of a ring structure. The winding 2212 of the stator assembly 221 may have a ring shape and surround the outside of the inner wall 2233.

The boss 223b may be disposed on the inner wall 2233 of the rotor 223a and positioned in the receiving cavity 2234. The boss 223b can be used to improve the stability of the rotor assembly 223 when it rotates. Specifically, the boss 223b may extend from the inner wall 2233 to the center of the receiving cavity 2234, and the height of the boss 223b extending to the center of the receiving cavity 2234 may be lower than a predetermined ration of the radial width of the receiving cavity 2234. The predetermined ratio may be 0.1, 0.22, 0.3, 0.33, etc. to prevent the boss 223b from blocking the receiving cavity 2234 too much and affecting the transmission optical path of the laser pulse. The boss 223b can rotate synchronously with the rotor 223a, and the boss 223b can be fixedly connect with the rotor 223a. For example, the boss 223b can be integrally formed with the rotor 223a, such as by injection molding. The boss 223b can also be formed separately from the rotor 223a. After the boss 223b and the rotor 223a are formed separately, the boss 223b may be fixed on the inner wall 2233 of the rotor 223a. For example, the boss 223b may be bonded to the inner wall 2233 by glue. In the embodiments of the present disclosure, the boss 223b may rotate synchronously with the yoke 2231, and the boss 223b may be fixedly connected with the yoke 2231.

Referring to FIG. 7, the positioning assembly 222 is positioned outside the inner wall 2233, and the positioning assembly 222 is used to restrict the rotor assembly 223 from rotating around the fixed rotating shaft 2235. The stator assembly 221 and the positioning assembly 222 surround the inner wall 2233 in a side by side manner. The positioning assembly 222 includes an annular bearing 2221, and the annular bearing 2221 surrounds the outer side of the inner wall 2233. The annular bearing 2221 is mounted on the housing body 211 and received in the scanning housing cavity 2115.

The annular bearing 2221 includes an inner ring structure 2222, an outer ring structure 2223, and a plurality of rolling elements 2224. The inner ring structure 2222 and the outer side of the inner wall 2233 are fixed to each other. The outer ring structure 2223 and the scanning housing 21 are fixed to each other. The rolling elements 2224 are positioned between the inner ring structure 2222 and the outer ring structure 2223, and the rolling elements 2224 can be used for a rolling connection between the outer ring structure 2223 and the inner ring structure 2222, respectively.

The prism 23 may be disposed in the receiving cavity 2234. Specifically, the prism 23 may be mounted in cooperation with the inner wall 2233 and fixedly connected to the rotor 223a, and the prism 23 may be positioned on the light path of the laser pulse. The prism 23 may rotate synchronously with the rotor 223a around the rotating shaft 2235. When the prism 23 rotates, the transmission direction of the laser light passing through the prism 23 can be changed. In the embodiments of the present disclosure, the prism is formed with a first surface 231, a second surface 232 opposite to the first surface 231, and a prism side wall 233 connecting the first surface 231 and the second surface 232. The first surface 231 may be inclined relative to the rotating shaft 2235, that is, the angle between the first surface 231 and the rotating shaft 2235 may not be 0° or 90°. The second surface 232 may be perpendicular to the rotating shaft 2235, that is, the angle between the second surface 232 and the rotating shaft 2235 may be 90°.

It can be understood that since the first surface 231 and the second surface 232 are not parallel, the thickness of the prism 23 may not be uniform, that is, the thickness of the prism 23 may not be the same everywhere, and there may be positioned with greater thickness and positions with less thickness. The position where the thickness of the prism 23 is the smallest, or the position where the thickness is the largest, or other specific positions can be defined as a zero position 235 of the prism 23 to facilitate subsequent detection of the rotational position of the prism 23. In one example, the thickness of the prism 23 may gradually increase in one direction. In the embodiments of the present disclosure, the prism 23 can be a wedge prism, and the zero position 235 can be positioned at a certain position on the side wall 233 of the prism. In other embodiments, the prism 23 may also be coated with an anti-reflection coating. The thickness of the anti-reflection coating may be equal to the wavelength of the laser pulse emitted by a light source 32 (shown in FIG. 11), which can reduce the loss when the laser pulse passes through the prism 23.

The installation relation between the prism 23 and the rotor 223a will be described below.

The optical element placed on the optical path can be used to change the optical path, and the relative position of the optical element is of great significance for the optical element to achieve corresponding functions. To ensure the accuracy of the installation position of the optical element, generally, after the optical element is installed in the lens barrel, the installation angle of the optical element needs to be detected, and the installation process is cumbersome. A first positioning structure 2236 may be formed on the inner wall 2233, and a second positioning structure 234 may be formed on the prism 23. When the prism 23 is installed in the receiving cavity 2234, the second positioning structure 234 may cooperate with the first positioning structure 2236 to align the zero position 235 of the prism 23 with a first specific position of the rotor 223a. In some embodiments, the first specific position can be any rotation position preset by the user. Through the cooperation of the first positioning structure 2236 and the second positioning structure 234, each time the user installs the prism 23 in the receiving cavity 2234, the zero position 235 of the prism 23 can be aligned with the first specific position, and there is no need to detect the relative rotation angle of the prism 23 with respect to the rotor 223a.

The first positioning structure 2236 may include a protrusion 2236 formed on the inner wall 2233, and the second positioning structure 234 may include a notch 234 formed on the side wall 233 of the prism. When the prism 23 is installed in the receiving cavity 2234, the protrusion 2236 may be complementary to the cutout 234, such that the protrusion 2236 can match the notch 234, and at the same time, the zero position of the prism can be aligned with the first specific position. In this way, even during the rotation, the prism 23 and the rotor assembly 223 will not rotate relative to each other.

The edge of the protrusion 2236 may be recessed toward the inner wall 2233 to form an escape groove 2237, and the junction of the notch 234 and the side wall 233 of the prism may be received in the escape groove 2237. It can be understood that the prism 23 is a precision optical device. The precision and completeness of the external dimensions of the prism 23 have a great impact on the optical effect of the prism 23, and the corners of the prism 23 are more susceptible to wear. By receiving the junction of the notch 234 and the side wall 233 of the prism in the escape groove 2237, the wear on the junction of the notch 234 and the side wall 233 of the prism can be prevented.

The protrusion 2236 may extend in the direction of the rotating shaft 2235, and the depth D of the protrusion 2236 extending in the direction of the rotating shaft 2235 may be greater than the thickness T of the prism 23 where the notch 234 is formed. That is, when the prism 23 is installed in the receiving cavity 2234, the notch 234 may match with the protrusion 22236, the prism 23 may not interfere with the end of the protrusion 2236, and the edge of the prism 23 may not be easily worn to cause chipping.

Of course, the specific forms of the first positioning structure 2236 and the second positioning structure 234 are not limited in the embodiments of the present disclosure, and may also have other specific forms. For example, the first positioning structure 2236 may include a notch formed on the inner side wall, and the second positioning structure 234 may include a protrusion formed on the side wall 233 of the prism, and the notch can match with the protrusion.

In one example, there may be one first positioning structure 2236 and one second positioning structure 234. The one first positioning structure 2236 and the one second positioning structure 234 may cooperate with each other, and the structure of the rotor 223a and the prism is simple. In another example, there may be a plurality of first positioning structures 2236, and the plurality of first positioning structures 2236 may be distributed at intervals along the circumferential direction of the inner wall 2233. There may be a plurality of second positioning structures 234, and each second positioning structure 234 may be used to cooperate with a corresponding first positioning structure 2236. When the rotor 223a rotates to drive the prism 23 to rotate, the forces of the two may be relatively dispersed and may not be concentrated on a certain second positioning structure 234, such that the prism 23 is not easily worn.

More specifically, in the embodiments of the present disclosure, there are two first positioning structures 2236 and two second positioning structures 234. The two first positioning structures 2236 may be symmetrical about a first cross-section M of the prism 23. In some embodiments, the first cross-section M may be defined as a plane passing through the rotating shaft 2235 and the second positioning structure 234 of the prism 23. Alternatively, the two first positioning structures 2236 may be symmetrical with about a second cross-section N of the prism 23. In some embodiments, the second cross-section N may be defined as a plane passing through the rotating shaft 2235 and perpendicular to the first cross-section M. It can be understood that the first positioning structure 2236 can be symmetrical about the first cross-section M and also symmetrical about the second cross-section N. Similar to the first positioning structure 2236, the second positioning structure 234 may also be symmetrical about the first cross-section M, or symmetrical about the second cross-section N, or symmetrical about the first cross-section M and the second cross-section N at the same time.

As described above, the thickness of the prism 23 may not be uniform. In some embodiments, the prism 23 may include a first end 236 and a second end 237. The thickness of the first end 236 may be greater than the thickness of the second end 237, the second end 237 and the boss 223b may be positioned on the same side of the rotating shaft 2235 of the rotor 223a, and the first end 236 and the boss 223b may be positioned on the opposite sides of the rotating shaft 2235. It can be understood that due to the uneven thickness of the prism 23, the prism 23 itself may be unstable and shake when it rotates, and this shaking may be transmitted to the rotor assembly 223, causing the entire rotor assembly 223 to be unstable during rotation. In one example, along the direction from the first end 236 to the second end 237, the thickness of the prism 23 may gradually decrease. In this embodiment, since the second end 237 and the boss 223b are positioned on the same side of the rotating shaft 2235 and the first end 236 and the boss 223b are positioned on opposite sides of the rotating shaft 2235, when the prism 23 and the rotor assembly 223 rotate together, the overall rotation of the prism 23 and the boss 223b is stable, and the rotor assembly 223 can be prevented from shaking. Specifically, the boss 223b can act as a counterweight at this time. The boss 223b may rotate synchronously with the prism 23. The torque relative to the rotating shaft 2235 when the boss 223b rotates with the second end 237 may be equal to the torque relative to the rotating shaft 2235 when the first end 236 rotates. In some embodiments, the second end 237 may be the end where the zero position 235 of the prism 23 is positioned.

In one example, the density of the boss 223b may be greater than the density of the rotor 223a, such that when the boss 223b is disposed in the receiving cavity 2234, while ensuring the same quality, that is, under the same weight, the size of the boss 223b may be set to be smaller to reduce the impact of the boss 223b on the laser pulse passing through the receiving cavity 2234. In another example, the density of the boss 223b may also be greater than the density of the prism 23, such that the size of the same bosses 223b can be designed as small as possible.

When the boss 233b is installed in the receiving cavity 2234, the/2223b may contact the prism 23 such that the boss 223b can be as close to the prism 23 as possible. Specifically, the boss 223b may be positioned on the side where the first surface 231 of the prism 23 is positioned, and the boss 223b may abut against the first surface 231 of the prism 23. When installing the prism 23, when the first surface 231 abuts against the boss 223b, it can be considered that the prism 23 is installed in the depth direction of the receiving cavity 2234. More specifically, the boss 223b may include a boss side wall 2230, and the boss side wall 2230 may abut against the first surface 231. In order for the boss 223b and the prism 23 to better match the weight, the boss 223b may be symmetrical about a first auxiliary surface S. In some embodiments, the first auxiliary surface S may be a plane perpendicular to the rotating shaft 2235 and passing through the center of the first surface 231. In addition, the boss 223b may also be symmetrical about a second auxiliary surface L. In some embodiments, the second auxiliary surface L may be a plane passing through the rotating shaft 2235, the first end 236, and the second end 237.

The boss side wall 2230 may be in the shape of a flat plate perpendicular to the rotating shaft 2235, and the boss side wall 2230 may also be in a stepped shape to simplify the manufacture process when the boss 223b and the rotor 223a are integrally formed. The boss side wall 2230 may also be inclined with respect to the rotating shaft 2235, that is, the boss side wall 2230 may not be perpendicular to the rotating shaft 2235. In one example, the inclination direction of the boss side wall 2230 may be the same as the first surface 231. The boss side wall 2230 may be attached to the first surface 231 such that the boss side wall 2230 and the first surface 231 can be as close as possible to maximize the weight of the boss 223b and reduce the height of the boss 223b, thereby reducing the blocking of the optical path by the boss 223b.

In one example, the projection range of the prism 23 on the rotating shaft 2235 may cover the projection range of the boss 223b on the rotating shaft 2235. The torque generated during the rotation of the boss 223b can be offset with the torque generated during the rotation of the first end 236 of the prism 23 without affecting the stability of the rotation of the rest of the rotor 223a.

In some embodiments, the driver 22 may include a plurality of rotor assemblies 223, a plurality of stator assemblies 221, and a plurality of prisms 23. Each prism 23 may be mounted on a corresponding rotor assembly 223, and each stator assembly 221 may be used to drive a corresponding rotor assembly 223 to drive the prism 23 to rotate. Each rotor assembly 223, each stator assembly 221, and each prism 23 may be the rotor assembly 223, the stator assembly 221, and the prism 23 in any of the above embodiments, and will not be described in detail here. The term “a plurality of” used in the present disclosure may indicate two or two items. After the laser beam passes through one prism 23 to change its direction, another prism 23 can also change its direction again to increase the ability of the scanning module 20 to change the laser propagation direction as a whole to scan a larger space. In addition, by setting different rotation directions and/or rotation speeds of the rotor assembly 223, the laser beam can scan a predetermined scanning shape. Further, each rotor assembly 223 may include a boss 223b, and each boss 223b can be fixed on the inner wall 2233 of the corresponding rotor assembly 223 to improve the dynamic balance of the rotor assembly 223 when it rotates.

The rotating shaft 2235 of the plurality of rotor assemblies 223 may be the same, and the plurality of prisms 23 may all rotate around the same rotating shaft 2235. The rotating shaft 2235 of the plurality of rotor assemblies 223 may also be different, and the plurality of prisms 23 may rotate around different rotating shafts 2235. In addition, in some embodiments, the plurality of prisms 23 may also vibrate in the same direction or in different directions, which is not limited in the embodiments of the present disclosure.

The plurality of rotor assemblies 223 may rotate relative to the corresponding stator assembly 221 at different rotation speeds to drive the plurality of prisms 23 to rotate at different rotation speeds. The plurality of rotor assemblies 223 may also rotate relative to the corresponding stator assembly 221 in different rotation directions, thereby driving the plurality of prisms 23 to rotate in different rotation directions. The plurality of rotor assemblies 223 may rotate at the same speed in opposite directions. For example, at least one rotor assembly 223 can rotate forward relative to the stator assembly 221, and at least one rotor assembly 223 can rotate in reverse relative to the stator assembly 221. At least one rotor assembly 223 can rotate relative to the stator assembly 221 at a first speed, and at least one rotor assembly 223 can rotate relative to the stator assembly 221 at a second speed. The first speed and the second speed may be the same or different.

Referring to FIG. 11, the controller 24 is connected to the driver 22, and the controller 24 can be used to control the driver 22 to drive the prism 23 to rotate based on a control instruction. Specifically, the controller 24 can be connected to the winding 2212 and used to control the magnitude and direction of the current on the winding 2212 to control the rotation parameters (rotation direction, rotation angle, rotation duration, etc.) of the rotor assembly 223 to achieve the purpose of controlling the rotation parameters of the prism 23. In one example, the controller 24 may include an electronic speed controller (ESC) 54, and the controller can be disposed on the ESC 54.

The detector 25 can be used to detect the rotation parameters of the prism 23. The rotation parameters of the prism 23 may include the rotation direction, the rotation angle, and the rotation speed of the prism 23. The detector 25 may include a code disc 251 and a photoelectric switch 252. The code disc 251 may be fixed connected to the rotor 223a and rotate synchronously with the rotor assembly 223. It can be understood that since the prism 23 rotates synchronously with the rotor 223a, the code disc 251 can rotate synchronously with the prism 23, and the rotation parameters of the prism 23 can be obtained by detecting the rotation parameters of the code disc 251. Specifically, the rotation parameters of the code disc 251 can be detected by the cooperation of the code disc 251 and the photoelectric switch 252.

A third positioning structure 2239 may be formed on the rotor 223a, and a fourth positioning structure 2511 may be formed on the code disc 251. The third positioning structure 2239 may cooperate with the fourth positioning structure 2511 such that the zero position of the code disc 251 can be aligned with a second specific position of the rotor 223a. When the prism 23 is installed in the receiving cavity 2234, the zero position 235 of the prism 23 may correspond to the first specific position of the rotor 223a. When the code disc 251 is installed on the rotor assembly 223, the zero position of the code disc 251 may be aligned with the second specific position of the rotor 223a. The first specific position and the second specific position may both be predetermined positions. Therefore, the zero position of the code disc 251 and the zero position 235 of the prism 23 may be at a predetermined angle, and the rotation parameters of the prism 23 may be obtained through the angle and the rotation parameters of the code disc 251. In one example, the first specific position and the second specific position may be the same position. At this time, the zero position 235 of the prism 23 may be aligned with the zero position of the code disc 251.

Referring to FIG. 9, in the embodiments of the present disclosure, a mounting ring 2238 is formed on the rotor 223a, and the third positioning structure 2239 includes a notch formed on the mounting ring 2238. The code disc 251 is sleeved on the mounting ring 2238. The fourth positioning structure 2511 includes positioning protrusions formed on the code disc 251, and the positioning protrusions can cooperate with the notch to align the zero position of the code disc 251 with the second specific position.

When there are a plurality of rotor assemblies 223 and prisms 23, there may be a plurality of code discs 251. Each code disc 251 may be installed on a corresponding rotor assembly 223 (the rotate rotor 223a), and each code disc 251 can be used to detect the rotation parameters of the prism 23 installed on the same rotor assembly 223. At least two code discs 251 can be installed in opposite directions. The at least two code discs 251 being installed in opposite directions may indicate that one code disc 251 is sleeved on one rotor 223a with its front side facing the rotor 223a, and the other code disc 251 is sleeved on the on the other rotor 223a with the back side facing the rotor 223a, where the front side and the back side may be two opposite end surfaces of the code disc 251. Of course, there may also be at least two code discs 251 in the same installation direction. The same installation direction may indicate that one code disc 251 is sleeved on one rotor 223a in the direction facing the rotor 223a, and the other code disc 251 is also sleeved on the other rotor 223a in the direction facing the rotor 223a. Alternatively, one code disc 251 may be sleeved on one rotor 223a with the back side facing the rotor 223a, and the other code disc 251 may also be sleeved on the other rotor 223a with the back side facing the rotor 223a.

The photoelectric switch 252 can be used to transmit optical signals and to receive the optical signals passing through the code disc 251. A light-passing hole can be formed on the code disc 251, and the light signal can pass through the light-passing hole, but may not pass through in positions other than the light-passing hole. When the code disc 251 rotates, the light-passing hole can also rotate, and the photoelectric switch 252 can continuously emit light signals. By analyzing the waveform of the optical signal received by the photoelectric switch 252 and other signals, the rotation parameters of the code disc 251 can be determined, and then the rotation parameters of the prism 23 can be obtained.

In conventional mechanical liar, the distance measurement module and the scanning module are not separated, and the entire distance measuring assembly can rotate around a certain axis. In the distance measuring assembly 20a provided in the embodiments of the present disclosure, the distance measuring module 30 and the scanning module 20 are separated, and the distance measuring module 30 remains stationary with the base 11 during rotation. In one example, the distance measuring module 30 and the distance measuring module 30 may be spaced apart such that the scanning module 20 can vibrate relative to the distance measuring module 30.

In some embodiments, the scanning module 20 and the distance measuring module 30 may be fixedly connected together to reduce vibration as a whole. In some embodiments, the scanning module 20 may be independently used for vibration reduction, and the distance measuring module 30 may be fixed to the base 11. These two technical solutions can greatly reduce the influence of the scanning module 20 on the measurement accuracy of the distance measuring module 30. If the first technical solution is adopted, the vibration of the scanning module 20 will be directly transmitted to the distance measuring module 30, and the displacement of the vibration (including the translational displacement and the rotational displacement) will have a one-to-one impact on the distance measurement accuracy. If the second technical solution is adopted, the vibration of the scanning module 20 will not be transmitted to the distance measuring module 30, and the displacement of the vibration is mainly in the scanning module 20, and the impact on the distance measurement accuracy will be greatly reduced. For example, in some distance measuring devices 100 provided in the embodiments of the present disclosure, the impact on the distance measurement accuracy may be about 10 to 1. That is, the vibration displacement of the scanning module 20 may be 10, and the impact on the distance measurement accuracy may be 1. In the following, the second technical solution is taken as an example for description in conjunction with the accompanying drawings.

Referring to FIG. 4, FIG. 6, and FIG. 11A, the distance measuring module 30 is rigidly fixed in the housing 10, the distance measuring module 30 and the scanning module 20 are arrange oppositely with a gap between them, and the distance measuring module 30 is disposed on the side of the base 11 close to the second cover side wall 1222 of the second cover. Further, the distance measuring module 30 is fixedly installed on the mounting protrusion 114. Specifically, the distance measuring module 30 includes a distance measuring housing 31, a light source 32, an optical path changing element 33, a collimating element 34, and a detector 35. A coaxial optical path may be used in the distance measuring module 30, that is, the light beam emitted from the distance measuring module 30 and the reflected light beam may share at least part of the optical path in the distance measuring module 30. Alternatively, the distance measuring module 30 may also sue an off-axis optical path, that is, the light beam emitted by the distance measuring module 30 and the reflected light beam may respectively be transmitted along different optical paths in the detection device.

In some examples, the light source 32 may include a transmitting circuit 320 shown in FIG. 11B. The detector 35 may include a receiving circuit 351, a sampling circuit 352, and an arithmetic circuit 353 shown in FIG. 11B, or further include a control circuit 354 shown in FIG. 11B.

The distance measuring housing 31 may be fixedly mounted on the mounting protrusion 114 and may be attached to the mounting protrusion 114. The mounting protrusion 114 can conduct the heat of the distance measuring module 30 to the base 11. Specifically, the distance measuring housing 31 includes a housing main body 311 and two protruding arms 312. The housing main body 311 includes a distance measuring housing top wall 3111, two distance measuring housing side walls 3112, a distance measuring housing bottom wall 3113, and two distance measuring housing end walls 3114. The distance measuring housing top wall 3111 and the distance measuring housing bottom wall 3113 may be positioned on opposite sides of the housing main body 311. The two distance measuring housing side walls 3112 may be respectively positioned on opposite sides of the housing main body 311, and may be connected to the distance measuring housing top wall 3111 and the distance measuring housing bottom wall 3113. The two distance measuring housing end walls 3114 may be positioned on opposite sides of the housing main body 311, and may be connected to the distance measuring housing top wall 3111, the distance measuring housing bottom wall 3113, and the two distance measuring housing side walls 3112. The housing main body 311 may further include a distance measuring housing cavity 3115 penetrating through the two distance measuring housing end walls 3114, and the distance measuring housing cavity 3115 may be aligned with the scanning housing cavity 2115. The distance measuring housing cavity 3115 may have a circular shape. Specifically, the axis of the distance measuring housing cavity 3115 may coincide with the axis of the scanning housing cavity 2115.

The two protruding arms 312 may respectively extend from the distance measuring housing side walls 3112 in a direction away from the distance measuring housing cavity 3115, and the two protruding arms 312 may be both positioned at the scanning housing bottom wall 2113. The protruding arm 312 may include a plurality of protruding arm mounting holes 3121, and the plurality of protruding arm mounting holes 3121 may correspond to the plurality of protrusion coupling holes 1140. Specifically, the number, size, and position of the protruding arm mounting holes 3121 may correspond to the number, size, and position of the protrusion coupling holes 1140. The two protruding arms 312 may be combined with the mounting protrusion 114 by a lock member (not shown in the accompanying drawings) to fix the distance measuring module 30 on the base 11. Specifically, the locking member may pass through the protruding arm mounting hole 3121 and then lock into the protrusion coupling hole 1140 to fix the two protruding arms 312 to the mounting protrusion 114, such that the distance measuring module 30 can be fixed on the base 11. When the distance measuring module 30 is fixed on the base 11, the distance measuring module 30 may be aligned with the receiving space 1124, and the receiving space 1124 may be used to receive the cables of the distance measuring module 30.

Referring to FIG. 11, the light source 32, the optical path changing element 33, the collimating element 34, and the detector 35 will be described below by taking the distance measuring module 30 using a first type of coaxial optical path.

The light source 32 can be installed on the distance measuring housing 31. The light source 32 can be used to emit laser pulse sequences. In some embodiments, the laser beam emitted by the light source 32 may be a narrow-bandwidth beam with a wavelength outside the visible light range. The light source 32 can be installed on the distance measuring housing side wall 3112, and the laser pulse sequence emitted by the light source 32 can enter the distance measuring housing cavity 3115. In some embodiments, the light source 32 may include a laser diode, through which nanosecond laser light can be emitted. For example, the laser pulse emitted by the light source 32 may last for 10 ns.

The collimating element 34 may be disposed on the light exit path of the light source 32 for collimating the laser beam emitted from the light source 32. That is, the laser beam emitted by the light source 32 can be collimated into parallel light. Specifically, the collimating element 34 may be installed in the distance measuring housing cavity 3115 and positioned at an end of the distance measuring housing cavity 3115 close to the scanning module 20. More specifically, the collimating element 34 may be positioned between the light source 32 and the scanning module 20. The collimating element 34 may also be used to condense at least a part of the returned light reflected by the object to be detected. The collimating element 34 may be a collimating lens or other elements capable of collimating a light bema. In one embodiment, an anti-reflection coating may be coated on the collimating element 34 to increase the intensity of the transmitted light beam.

The optical path changing element 33 may be installed in the distance measuring housing cavity 3115 and may be disposed on the optical path of the light source 32. The optical path changing element 33 may be used to change the optical path of the laser beam emitted by the light source 32, and to combine the output optical path of the light source 32 and the receiving optical path of the detector 35.

Specifically, the optical path changing element 33 may be positioned on the side of the collimating element 34 opposite to the scanning module 20. The optical path changing element 33 may be a mirror or a half mirror. The optical path changing element 33 may include a reflective surface 332, and the light source 32 may be disposed opposite to the reflective surface 332. In this embodiment, the optical path changing element 33 may be a small reflector, which can change the optical path direction of the laser beam emitted by the light source 32 by 90° or other angles.

The detector 35 may be installed on the distance measuring housing 31 and received in the distance measuring housing cavity 3115. The detector 35 may be positioned at one end of the distance measuring housing cavity 3115 away from the scanning module 20, and the detector 35 and the light source 32 may be disposed on the same side of the collimating element 34. In some embodiments, the detector 35 may be directly opposite to the collimating element 34, and the detector 35 may be used to convert at least part of the returned light passing through the collimating element 34 into an electrical signal.

When the distance measuring device 100 is working, the light source 32 may emit laser pulses. The laser pulse may be collimated by the collimating element 34 after the optical path direction is changed (which can be 90° or other angles) by the optical path changing element 33. The collimated laser pulse may be transmitted by the prism 23 to change the transmission direction and then emitted and projected onto the object to be detected. After the laser pulse reflected by the object to be detected passes through the prism 23, at least part of the returned light can be condensed onto the detector 35 by the collimating element 34. The detector 35 can convert at least part of the returned light passing through the collimating element 34 into electrical signal pulses, and the distance measuring device 100 can determine the laser pulse receiving time based on the rising edge time and/or falling edge time of the electrical signal pulse. In this way, the distance measuring device 100 can use the pulse receiving time information and the pulse sending time information to calculate the flight time, thereby determining the distance from the object to be detected to the distance measuring device 100.

Referring to FIG. 12, the light source 32, the optical path changing element 33, the collimating element 34, and the detector 35 will be described below by taking the distance measuring module 30 using a second type of coaxial optical path. At this time, the structure and position of the collimating element 34 may be the same as the structure and position of the collimating element 34 in the first type of coaxial optical path. The difference may be that the optical path changing element 33 may be a large reflector, the large reflector may include a reflective surface 332, and the middle position of the large reflector may include a light-passing hole. The detector 35 and the light source 32 may still be disposed on the same side of the collimating element 34. Compared with the aforementioned first coaxial optical path, the positions of the detector 35 and the light source 32 may be interchanged. That is, the light source 32 and the collimating element 34 may be directly opposite, the detector 35 may be opposed to the reflective surface 332, and the optical path changing element 33 may be positioned between the light source 32 and the collimating element 34.

When the distance measuring device 100 is working, the light source 32 may emit laser pulses. The laser pulse may pass through the light-passing hole of the optical path changing element 33 and may be collimated by the collimating element 34. The collimated laser pulse may be transmitted by the prism 23 to change the transmission direction and then emitted and projected onto the object to be detected. After the laser pulse reflected by the object to be detected passes through the prism 23, at least part of the returned light can be condensed onto the reflective surface 332 of the optical path changing element 33 by the collimating element 34. The reflective surface 332 may reflect the at least part of the returned light to the detector 35, and the detector 35 can convert the at least part of the returned light into an electrical signal pulse. The distance measuring device 100 may determine the laser pulse receiving time based on the rising edge time and/or falling edge time of the electrical signal pulse. In this way, the distance measuring device 100 can use the pulse receiving time information and the pulse sending time information to calculate the flight time, thereby determining the distance from the object to be detected to the distance measuring device 100. In this embodiment, the size of the optical path changing element 33 may be relatively large and may cover the entire field of view of the light source 32. The returned light may be directly reflected by the optical path changing element 33 to the detector 35, avoiding the blocking of the returned optical path by the optical path changing element 33 itself, increasing the intensity of the returned light detected by the detector 35, and improving the distance measurement accuracy.

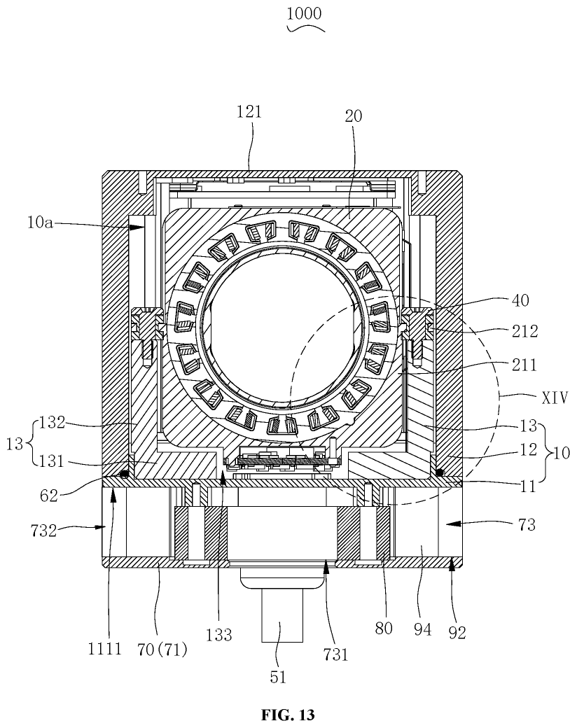

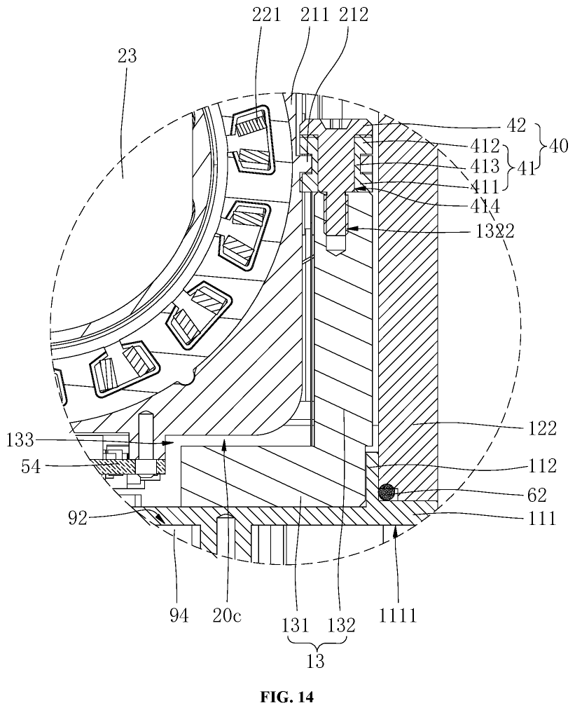

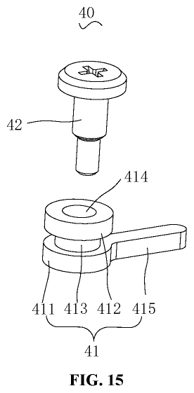

Referring to FIG. 6, FIG. 7, and FIG. 13 to FIG. 15. The flexible connection assembly 40 can be used to connect the scanning housing 21 to the mounting seat 13, and the scanning housing 21 can be received in the mounting groove 133. The flexible connection assembly 40 can provide a gap 20c between the scanning module 20 and the mounting seat 13 to provide a vibration space for the scanning module 20. In this embodiment, there may be at least toe flexible connection assemblies 40 that correspond to at least two joints 20b respectively, and each flexible connection assembly 40 may be disposed at the corresponding joint 20b. The central line between the two joints 20b may be in the same plane as the rotating shaft 2235 of the rotor 223a. In addition, the flexible connection assemblies 40 may also correspond to the flange mounting holes 2121, and each flexible connection assembly 40 may be installed at the corresponding flange mounting hole 2121 respectively. Specifically, the flexible connection assembly 40 may include a flexible connector 41 and a fastener 42. The flexible connector 41 and the flange 212 may be installed on the top end 1321 by a fastener 42.

The flexible connector 41 may be disposed between the mounting seat 13 and the scanning housing 21, and the flexible connector 41 may be positioned between the scanning housing top wall 2111 and the scanning housing bottom wall 2113. Further, the flexible connector 41 may be positioned closer to the rotating shaft 2235 of the rotor assembly 223 than the scanning housing bottom wall 2113. Each flexible connector 41 may include a flexible first supporting part 411, a flexible connecting part 413, and a flexible second connecting part 412. The flexible first supporting part 411 and the flexible second connecting part 412 may be respectively connected to opposite ends of the flexible connecting part 413. The flexible connector 41 may include a through hole 414 penetrating the flexible first supporting part 411, the flexible connecting part 413, and the flexible second connecting part 412. The flexible connecting part 413 may pass through the flange mounting hole 2121, and the flexible first supporting part 411 and the flexible second connecting part 412 may be respectively positioned on opposite sides of the flange 212. The fastener 42 may pass through the through hole 414 and may be combined with the mounting arm coupling hole 1322 on the mounting arm 132 to connect the scanning module 20 to the mounting arm 132 (that is, the two flanges 212 may be connected to the top end 1321 of the mounting arm 132 by the flexible connection assembly 40). At this time, the flexible first supporting part 411 may be positioned between the flange 212 and the top end 1321. In this embodiment, the cross section of the flexible connector 41 cut by a plane passing through the axis of the through hole 414 may be an “I” shape. The flexible connector 41 may be a rubber pad.

Further, in this embodiment, the flexible connector 41 may further include a supporting protrusion 415. The supporting protrusion 415 may protrude from the flexible first supporting part 411, and the supporting protrusion 415 may be positioned between the flange 212 and the top end 1321 to increase the contact area with the flange 212 to provide better flexible connection force. In this embodiment, the central line between the at least two flexible connectors 41 and the rotating shaft 2235 of the rotor 223a may be in the same plane, and the plane may be parallel to the mounting plate 131 or any one of the sub-mounting plates 1310. In another embodiment, the central line of the two flanges 212 and the rotating shaft 2235 of the rotor 223a may be in the same plane, and the plane may be parallel to the mounting plate 131 or any one of the sub-mounting plates 1310. In another embodiment, the central line of the two junctions between the two flanges 212 and the two flexible connectors 41 may be in the same plane as the rotating shaft 2235 of the rotor 223a, and the plane may be parallel to the mounting plate 131 or any one of the sub-mounting plates 1310. In another embodiment, the scanning housing 21 may include a plurality of connection points connected by the flexible connectors 41. The connecting line between the plurality of connection points may be in the same plane as the rotating shaft 2235 of the rotor 223a, and the plane may be parallel to the mounting plate 131 or any one of the sub-mounting plates 1310. Regardless the arrangements described above, each arrangement can reduce the position and angle deviation of the distance measuring module 30 caused by the horizontal centrifugal force when the rotor 223a rotates.

The scanning module 20, the flexible connection assembly 40, and the housing 10 can form a vibration system, and a natural frequency f0 of the vibration system may be smaller than the vibration frequency of the scanning module 20 or greater than the vibration frequency of the scanning module 20. Further, the natural frequency f0 of the vibration system may be less than 1000 Hz, and the ratio of a rotation frequency f to f0 of the rotor 223a may be less than ⅓ or greater than ¼. That is, f/f0<⅓, or f/f0>1.4. In some embodiments, f/f0>1.41. When f/f0<⅓, the vibration of the scanning module 20 caused by the rotation of the rotor 223a may be magnified by 1 to 1.1 times. When f/f0>1.4 or f/f0>1.41, the vibration of the scanning module 20 caused by the rotation of the rotor 223a may be magnified by a factor of less than 1. When ⅓<f/f0<1.41, the vibration of the scanning module 20 caused by the rotation of the rotor 223a may be magnified by 1 to infinite times. Especially when f/f0=1, the vibration of the scanning module 20 caused by the rotation of the rotor 223a may be magnified infinitely.

Generally, when the rotor 223a rotates, the scanning module 20 will vibrate due to the rotation of the rotor 223a. Since the scanning module 20 is connected to the mounting seat 13 of the housing 10 through the flexible connection assembly 40, and there is a gap 20c between the scanning module 20 and the mounting seat 13 to provide a vibration space for the scanning module 20, the flexible connection assembly 40 can prevent direct contact between the scanning module 20 and the housing 10, and can reduce or even avoid the transmission of the vibration of the scanning module 20 to the housing 10 (and the mounting seat 13). Further, since the natural frequency f0 of the vibration system is less than 1000 Hz, the high frequency vibration higher than 1000 Hz on the scanning module 20 can hardly be transmitted to the housing 10. Furthermore, the ratio of the rotation frequency f of the rotor 223a to the natural frequency f0 may be less than ⅓ or greater than 1.4, which can prevent the vibration of the scanning module 20 from being transmitted to the housing 10 due to the rotation of the rotor 223a. In addition, the noise source in the scanning module 20 generally comes from the high-speed rotating rotor 223a, and the human ear is more sensitive to high-frequency noise above 1000 Hz. The housing 10 in the scanning module 20 in the present disclosure can form a sealed receiving cavity 10a, which has high sealing level, and high-frequency noise can only pass through the air in the housing 10, penetrate the housing 10, and then spread to the outside. The housing 10 can be designed as sealed structure to increase the acoustic resistance between the rotor 223a and the outside. Therefore, the sealed housing 10 (and the receiving cavity 10a) can greatly reduce the noise transmitted to the housing 10 compared to the sound source (the rotor 223a), which can improve the user experience. Further, since the distance measuring module 30 is rigidly fixed in the housing 10, the vibration of the scanning module 20 has little effect on the distance measuring module 30, thereby ensuring the stability of the relative position of the distance measuring module 30 and the distance measuring device 100, and improving the accuracy of the distance measurement. Generally, the rotor 223a of the scanning module 20 inevitably has a certain imbalance. When the rotor 223a rotates at a high speed, centrifugal force can be generated along the shaft. In this embodiment, the central line between the two flexible connectors 41 may be in the same plane as the rotating shaft 2235 of the rotor 223a; or, the central line of the two flanges 212 and the rotating shaft 2235 of the rotor 223a may be in the same plane; or, the central line of the two junctions between the flanges 212 and the two flexible connectors 41 may be in the same plane as the rotating shaft 2235 of the rotor 223a; or, the line between the connection points of the scanning housing 21 and the plurality of flexible connectors 41 may be in the same plane as the rotating shaft 2235 of the rotor 223a, which can reduce the horizontal centrifugal force causing the position and angle deviation of the scanning module 20.

Referring to FIG. 4 and FIG. 6, the circuit board assembly 50 includes a connector 51, a first electrical connector 52, a second electrical connector 53, and an electric adjustment board 54.

Referring to FIG. 16, the connector 51 passes through the base 11 form the receiving cavity 10a. The connector 51 can be used to connect the electronic components outside the distance measuring device 100 and the distance measuring device 100. Specifically, one end of the connector 51 is connected to the scanning module 20 and the distance measuring module 30, and the other end is connected to the electronic components outside the distance measuring device 100.

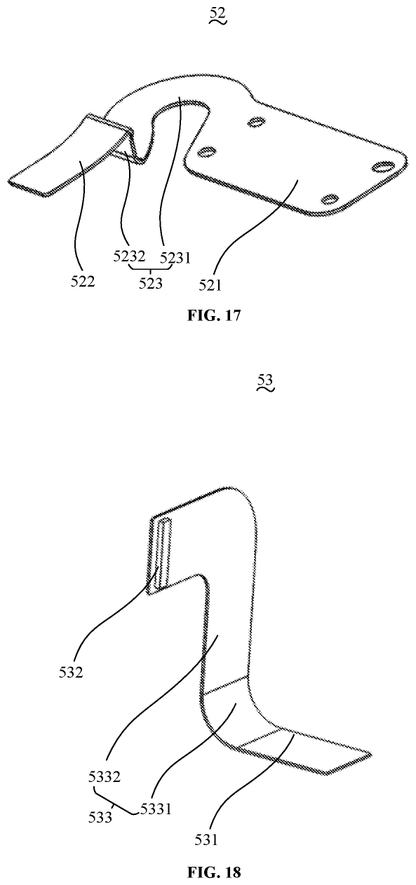

Referring to FIG. 6 and FIG. 17, the first electrical connector 52 includes a first scanning connecting part 521 for connecting with the scanning module 20, a first distance measuring connecting part 522 for connecting with the distance measuring module 30, and a flexible first bending part 523 positioned between the first scanning connecting part 521 and the first distance measuring connecting part 522. The first scanning connecting part 521 and the first distance measuring connecting part 522 are respectively connected to opposite ends of the flexible first bending part 523. The first scanning connecting part 521 is disposed on the scanning housing top wall 2111, and the first distance measuring connecting part 522 is disposed on the distance measuring housing top wall 3111. The flexible first bending part 523 includes a first sub-bending part 5231 and a second sub-bending part 5232. The opposite ends of the first sub-bending part 5231 are respectively connected to the first scanning connecting part 521 and the second sub-bending part 5232, and the opposite ends of the second sub-bending part 5232 are respectively connected to the first distance measuring connecting part 522 and the first sub-bending part 5231. The first sub-bending part 5231 and the second sub-bending part 5232 may be respectively in two different planes, the first scanning connecting part 521 and the first sub-bending part 5231 may be in the same plane, and the first scanning connecting part 521 and the first distance measuring connecting part 522 may be respectively in two different planes. In this embodiment, a circuit for controlling the photoelectric switch 252 is disposed on the first scanning connecting part 521, and the first distance measuring connecting part 522 can be electrically connected to the photoelectric switch 252 to realize the control of the photoelectric switch 252.

In conventional technology, the power supply and communication between the distance measuring module 30 and the scanning module 20 are connected through a flexible printed circuit (FPC) line. The FPC line is prone to fatigue stress due to the vibration of the scanning module 20, resulting in a poor socket contact and FPC line crack in a short amount of time. In this embodiment, by arranging the flexible first bending part 523 on the first electrical connector 52, and the first sub-bending part 5231 and the second sub-bending part 5232 being respectively in two different planes (the two planes may have a height difference), the first scanning connecting part 521 and the first distance measuring connecting part 522 may be respectively in two different planes (the two planes may also have a height difference). The flexible first bending part 523 can allow the first electrical connector 52 to have a larger deformation margin during the vibration process of the scanning module 20, thereby greatly reducing the stress caused by the vibration of the scanning module 20 on the first electrical connector 52, and improving the reliability of the distance measuring device 100.

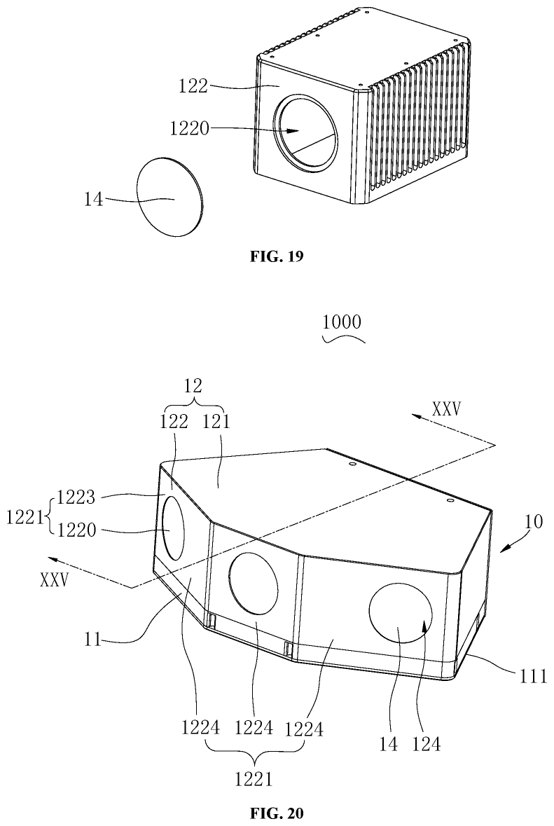

Referring to FIG. 6 and FIG. 18, the second electrical connector 53 includes a second scanning connection part 531, a second distance measuring connection part 532, and a flexible second bending part 533 positioned between the second scanning connection part 531 and the second distance measuring connection part 532. The second scanning connection part 531 and the second distance measuring connection part 532 are respectively connected to opposite ends of the flexible second bending part 533. The second scanning connection part 531 is disposed on the scanning housing bottom wall 2113. The second distance measuring connection part 532 is connected to the distance measuring housing side walls 3112 after passing through the scanning housing side wall 2112. The flexible second bending part 533 includes a third sub-bending part 5331 and a fourth sub-bending part 5332. The opposite ends of the third sub-bending part 5331 are respectively connected to the second scanning connection part 531 and the fourth sub-bending part 5332, and the opposite ends of the fourth sub-bending part 5332 are respectively connected to the second distance measuring connection part 532 and the third sub-bending part 5331. The third sub-bending part 5331 and the fourth sub-bending part 5332 may be respectively in two different planes. The second distance measuring connection part 532 and the fourth sub-bending part 5332 may be in the same plane. The second scanning connection part 531 and the second distance measuring connection part 532 may be respectively in two different planes.

In conventional technology, the power supply and communication between the distance measuring module 30 and the scanning module 20 are connected through a FPC line. The FPC line is prone to fatigue stress due to the vibration of the scanning module 20, resulting in a poor socket contact and FPC line crack in a short amount of time. In this embodiment, by arranging the flexible second bending part 533 on the second electrical connector 53, and the third sub-bending part 5331 and the fourth sub-bending part 5332 being respectively in two different planes, the second scanning connection part 531 and the second distance measuring connection part 532 can be respectively in two different planes. The flexible second bending part 533 can allow second electrical connector 53 to have a larger deformation margin during the vibration process of the scanning module 20, thereby greatly reducing the stress caused by the vibration of the scanning module 20 on the second electrical connector 53, and improving the reliability of the distance measuring device 100.

The electric adjustment board 54 can be disposed corresponding to the scanning housing bottom wall 2113. The second scanning connection part 531 can be electrically connected to the electric adjustment board 54, and the second distance measuring connection part 532 can be electrically connected to the power supply circuit (not shown in the accompany drawings) disposed on the distance measuring housing side walls 3112, such that the power supply circuit can supply power to the electric adjustment board 54.

To improve the environmental adaptability of the distance measuring device, a higher level of waterproof sealing is needed for the distance measuring device. Due to the high level of waterproof sealing of the distance measuring device, the heat in the distance measuring device can be difficult to dissipate into the air, and the distance measuring device may overheat during use. In the present disclosure, a heat dissipation structure is provided to dissipate heat of the distance measuring device. The following describes the specific heat dissipation structure with examples.

Referring to FIG. 4, the heat conducing element 61 can be disposed between the housing 10 and the scanning module 20; or, the heat conducing element 61 can be disposed between the housing 10 and the distance measuring module 30; or, the heat conducing element 61 can not only be disposed between the housing 10 and the scanning module 20, but also between the housing 10 and the distance measuring module 30. In some embodiments, the heat conducing element 61 may be made of a heat conducting material. For example, the heat conducing element 61 may be made of a heat conducting material such as copper, aluminum, etc. Alternatively, the heat conducing element 61 may be made of non-metallic heat conducting materials, such as heat conductive silicon, heat conductive resin, and heat conductive plastic. Specifically, when the heat conducing element 61 is disposed between the housing 10 and the scanning module 20, the heat conducing element 61 can be disposed between the scanning housing bottom wall 2113 and the installation space 1122. When the heat conducing element 61 is disposed between the housing 10 and the distance measuring module 30, the distance detection device can be disposed between the distance measuring housing bottom wall 3113 and the receiving space 1124. Of course, in other embodiments, the heat conducing element 61 may wrap any one or more of the scanning housing side wall 2112, the scanning housing end wall 2114, or the scanning housing top wall 2111. Similarly, the heat conducing element 61 can wrap any one or more of the distance measuring housing side walls 3112, the distance measuring housing end wall 3114, or the distance measuring housing top wall 3111. When the distance measuring device 100 is working, the scanning module 20 and/or the distance measuring module 30 can both generate heat, and the arrangement of the heat conducing element 61 can reduce the heat being transferred from the scanning module 20 and/or the distance measuring module 30 to the housing 10, and improving the heat dissipation efficiency of the distance measuring device 100. In addition, the housing 10 may also be made of a heat conductive material, which can further improve the heat dissipation efficiency of the distance measuring device 100.

The sealing member 62 can be disposed on the base 11 and surround the limiting wall 112, and the sealing member 62 can be positioned between the cover side wall 122, the limiting wall 112, and the base 11. The arrangement of the sealing member 62 can prevent external impurities, moisture, etc. from entering the housing 10, thereby achieving the functions of dustproof and waterproof. In this way, the external impurities, moisture, etc. can be prevented from affecting the normal operation of the scanning module 20 and the distance measuring module 30, as such, the distance measuring accuracy can be improved, and the service life of the distance measuring device 100 can be extended.

Referring to FIG. 16, the sound absorbing member 63 may be made of sound absorbing material, which can be sponge, foam, rubber, etc. The sound absorbing member 63 can be disposed on the inner surface of the receiving cavity 10a. That is, the sound absorbing member 63 can be disposed on the base 11, such as on the bottom plate 111 at a position avoiding the scanning module 20 and the distance measuring module 30. Alternatively, the sound absorbing member 63 can also be disposed on the inner surface of any one of the cover top wall 121 and the cover side wall 122. The sound absorbing member 63 can be bonded to the inner surface of the receiving cavity 10a by glue. The noise source in the scanning module 20 generally comes from the high-speed rotating rotor 223a, and the human ear is more sensitive to high-frequency noise above 1000 Hz. The sound absorbing member 63 in the present disclosure can greatly attenuate the noise transmitted to the housing 10 compared to the sound source (the rotor 223a), which can improve the user experience.

Referring to FIG. 2, FIG. 4, and FIG. 9. It can be understood that, in other embodiments, the housing 10 further includes a protective cover 14, and the protective cover 14 can be detachably installed or fixedly installed at the light-transmitting area 1220 of the cover 12. At this time, the light-transmitting area 1220 may be a through hole. The laser pulse passing through the prism 23 can be emitted from the protective cover 14 to the outside of the housing 10. The base 11, the cover 12, and the protective cover 14 together can form a sealed receiving cavity 10a. At this time, the protective cover 14 may be made of materials with high light transmittance such as plastic, resin, and glass. When the protective cover 14 is detachably installed at the light-transmitting area 1220 of the cover 12, on one hand, it is convenient to replace the protective cover 14, and on the other hand, it is convenient to clean the protective cover 14, thereby preventing impurities accumulated in the light-transmitting area 1220 from affecting the optical path of the laser beam, and reducing the accuracy of distance detection.

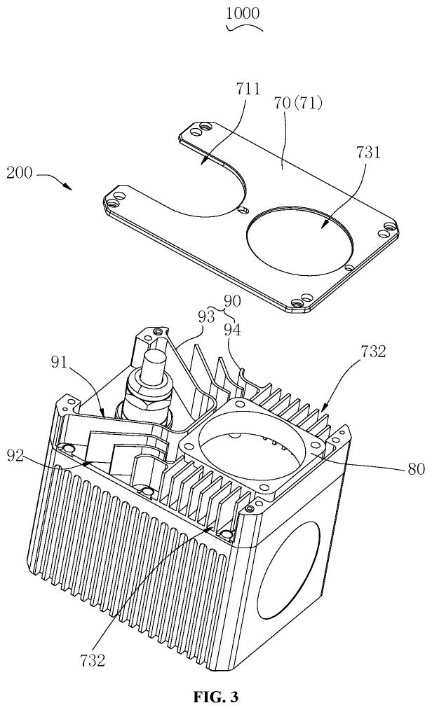

Referring to FIG. 3 to FIG. 5, the heat dissipation structure 200 includes a baffle assembly 70 and a fan 80. The baffle assembly 70 and the fan 80 can be disposed on the housing 10, and the baffle assembly 70 and the housing 10 together can form a heat dissipation air duct 73. The heat dissipation structure 200 may be formed with an air inlet 731 and an air outlet 732 connected to the heat dissipation air duct 73 and the outside of the distance detection device 1000. The fan 80 may be disposed in the heat dissipation air duct 73 and positioned at the air inlet 731 and/or the air outlet 732.

Specifically, the baffle assembly 70 includes a baffle 71. The baffle 71 is disposed on the side of the base 11 opposite to the cover 12, and the baffle 71 and the base 11 jointly enclose a heat dissipation air duct 73. The two air outlets 732 are formed between the opposite ends of the baffle 71 and the base 11, and the baffle 71 includes an air inlet 731 between the two air outlets 732. The fan 80 is installed at the air inlet 731. The baffle 71 is disposed parallel to the base bottom surface 1111, and a heat dissipation air channel is formed between the base bottom surface 1111 and the baffle 71. The baffle 71 further includes a baffle hole 711, and the end of the connector 51 away from the base 11 extends from the baffle hole 711 to the outside of the baffle 71.

In this embodiment, the fan 80 is installed on the base 11 and positioned at the air inlet 731. The fan 80 includes a first end surface 81, a second end surface 82, a first side surface 83, and a second side surface 84. The first end surface 81 and the second end surface 82 are positioned on opposite sides of the fan 80, and the first side surface 83 and the second side surface 84 are positioned on opposite side of the fan 80, and both are connected to the first end surface 81 and the second end surface 82. The first end surface 81 is opposed to the base 11 at a gap, and the second end surface 82 is attached to the baffle 71. The two air outlets 732 are respectively disposed on the side where the first side surface 83 is positioned and the side where the second side surface 84 is positioned. In this embodiment, the fan 80 may be an axial fan.

When the heat dissipation structure 200 dissipates the distance measuring device 100, the fan 80 blows air toward the base 11. The cold air blown by the fan 80 absorbs the heat on the base 11 (the heat generated by the scanning module 20, the distance measuring module 30, etc. and transmitted to the base 11) and then becomes hot air. The hot air is discharged from the two air outlets 732 after passing through the heat dissipation air duct 73, thereby taking away the heat from the base 11, and realizing the heat dissipation of the distance measuring device 100 with high heat dissipation efficiency. Since the heat of the distance measuring device 100 is mainly concentrated on the base 11, the heat dissipation structure 200 can be disposed on the base 11 and blow cold air directly to the base 11, and the hot air can be discharged from both sides, which can maximize the effectiveness of heat dissipation.

Further, the heat dissipation structure 200 may further include a plurality of heat sinks 90 disposed on the base 11 at intervals. The plurality of heat sinks 90 can be housed in the heat dissipation air duct 73 and disposed on the air path from the air inlet 731 to the air outlet 732. The heat sink 90 includes a first surface 91 and a second surface 92 opposite to each other. The first surface 91 of each heat sink 90 can be attached to the baffle 71, and the second surface 92 can be attached to the base bottom surface 1111. In this embodiment, the plurality of heat dissipation fins 90 include at least one heat sink 93 and a plurality of second heat sinks 94, and the first heat sink 93 separates the plurality of second heat sinks 94 from the connector 51. At this time, the baffle 71, the base 11, and the heat sink 90 jointly form a heat dissipation air duct 73. The plurality of second heat sinks 94 are symmetrically distributed at the two air outlets 732. Part of the second heat sinks 94 at each air outlet 732 may be perpendicular to the first side surface 83, and part of the second heat sinks 94 may be inclined to the second side surface 84. When the heat dissipation structure 200 dissipates the distance measuring device 100, the fan 80 blows air toward the base 11. The cold air blown by the fan 80 absorbs the heat on the base 11 (the heat generated by the scanning module 20, the distance measuring module 30, etc. and transmitted to the base 11) and then becomes hot air. When the hot air passes through the heat dissipation air duct 73, it also takes away the heat on the heat sink 90 and discharges it from the two air outlets 732, thereby discharging the heat on the base 11 and realizing the heat dissipation of the distance measuring device 100. Due to the additional heat sink 93, the heat concentrated on the base 11 can be transferred to the heat sink 93, thereby increasing the heat dissipation area. In addition, the heat sink 93 can be disposed in the heat dissipation air duct 73, such that the heat on the heat sink 93 can also follow the air flow quickly out of the air outlets 732 on both sides, which further improves the heat dissipation efficiency. In addition, since the heat sink 93 separates the plurality of second heat sinks 94 from the connector 51, the first surface 91 of each heat sink 90 is attached to the baffle 71, and the second surface 92 is attached to the base bottom surface 1111, the air flow can be prevented from entering the baffle hole 711 and affecting the normal operation of the connector 51.

Referring to FIG. 20 to FIG. 22, an embodiment of the present disclosure further provides another distance detection device 1000. The distance detection device 1000 includes a distance measuring device 100 and a heat dissipation structure 200.

The conventional lidar can transmit laser light to target objects within a certain angle range by changing the angle of laser propagation, or receiver laser light from a certain angle range, and use it to detect the surrounding environment with a certain angle range. However, the range of the angle that the lidar can detect is relatively small, and it cannot detect the surrounding environment in a larger direction. In the embodiments of the present disclosure, by fixing a plurality of distance measuring assemblies in a housing, the plurality of distance measuring assemblies can be calibrated to each other in advance, such that the plurality of distance measuring assemblies with a smaller field of view (FOV) can be used as a distance measuring assembly with a larger FOV. The following describes the specific structure with examples.

The distance measuring device 100 may include a housing 10 and a plurality of distance measuring assemblies 20a. The plurality of distance measuring assemblies 20a may be installed in the housing 10. There may be overlap in the field of view of two adjacent distance measuring assemblies 20a, and each distance measuring assembly 20a may be used to measure the distance from the object to be measured in the corresponding field of view to the distance detection device 1000. By arranging a plurality of distance measuring assemblies 20a, a distance measuring assembly 20a with larger field of view can be obtained to increase the overall field of view of the distance detection device 1000. At the same time, the ranges of field of views of two adjacent distance measuring assemblies 20a can overlap, thereby avoiding a blind spot of the field of view between two adjacent distance measuring assemblies 20a. In addition, since the plurality of distance measuring assemblies 20a are pre-installed in the same housing 10, the calibration parameters such as the relative positions of the plurality of distance measuring assemblies 20a can be relatively fixed. When the plurality of distance measuring assemblies 20a need to be used for a common distance measurement, the plurality of distance measuring assemblies 20a do not need to be calibrated, which simplifies the operation.

Specifically, the types and structures of the plurality of distance measuring assemblies 20a may be the same or different, or there may be at least two distance measuring assemblies 20a of the same type and structure in the plurality of distance measuring assemblies 20a, and there may also be distance measuring assemblies 20a of different types and structures, which is not limited in the embodiments of the present disclosure. In the embodiments of the present disclosure, the types and structures of the plurality of distance measuring assemblies 20a are the same to save replacement and maintenance costs.

Referring to FIG. 2 and FIG. 4, the distance measuring device 100 further includes a flexible connection assembly 40, a circuit board assembly 50, a heat conducing element 61, a sealing member 62, and a sound absorbing member 63. For the specific structures of the plurality of distance measuring assemblies 20a, the housing 10, the circuit board assembly 50, the heat conducing element 61, the sealing member 62, and the sound absorbing member 63, reference may be made to the structure description of the distance measuring device 100 in any of the above embodiments. The descriptions of the same parts will not be repeated here, and the following will focus on the different parts.

There may be a plurality of distance measuring assemblies 20a, and plurality may be two or more. The embodiment the present disclosure takes three distance measuring assemblies 20a as an example for the following description. It can be understood that the specific number of the distance measuring assemblies 20a may not be limited to three, and may also be other numbers, such as four, five, seven, etc. The plurality of distance measuring assemblies 20a may be radially installed in the housing 10, that is, the plurality of distance measuring assemblies 20a may emit detection signals (laser pulses) around a common point. In one example, the angles of the central axes of any two adjacent distance measuring assemblies 20a may be equal. Of course, in other embodiments, the angles between the central axes of two different distance measuring assemblies 20a may be unequal. In some embodiments, the central axis may be understood as the straight line where the emitted laser light is positioned without changing the laser direction through the prism 23. Or, the central axis may be understood as the straight line where the rotating shaft 2235 of the rotor 223a is positioned.

The angle between the central axes of two adjacent distance measuring assemblies 20a may be less than half of the sum of the angle of the field of view of the two adjacent distance measuring assemblies 20a, such that there can be overlaps in the angles of the field of views of the two adjacent distance measuring assemblies 20a, and no blind zone of the field of view can be formed between the two distance measuring assemblies 20a. Specifically, in one example, the angle between the central axes of two adjacent distance measuring assemblies 20a may be less than 80% or 90% of the angle of the field of view of any of the two adjacent distance measuring assemblies 20a. In another example, the angle between the central axes of two adjacent distance measuring assemblies 20a may be greater than 30% of the angle of the field of view of any one of the two adjacent distance measuring assemblies 20a. In this way, while there may be no blind zone of the angle of the field of view between two adjacent distance measuring assemblies 20a, the total range of the field of view of the distance detection device 1000 will not be too small. The size of the field of view of the plurality of distance measuring assemblies 20a can be the same or different, and can be set based on needs.

In some implementations, the field of views of the plurality of distance measuring assemblies 20a may be sequentially spliced along the same direction, such that the spliced distance measuring device can have a larger field of view in this direction and a smaller field of view in the direction perpendicular to this direction. In some application scenarios, such as in vehicles or robots, since the need for the detection angle of the surrounding environment in the horizontal direction may be greater than the need for the detection angle of the surrounding environment in the vertical direction, splicing the field of views of the plurality of distance measuring assemblies 20a in the same direction may be more suitable for this type of application scenario.

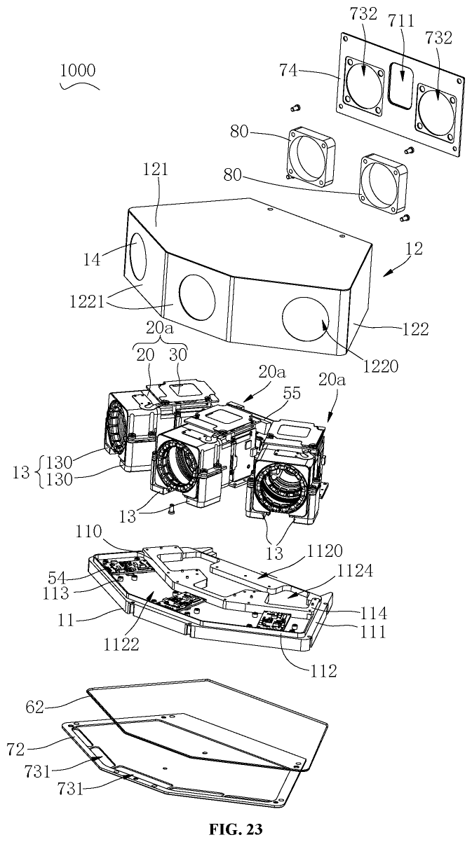

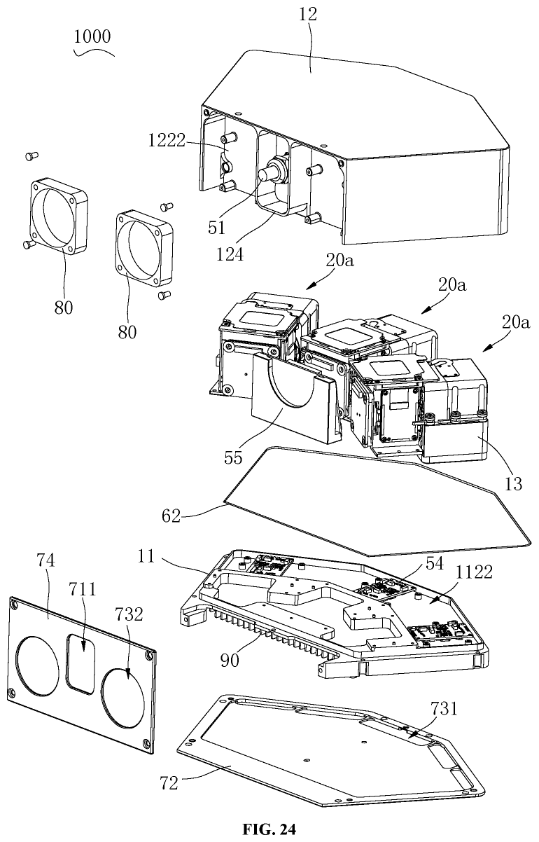

Referring to FIG. 23 and FIG. 24, the housing 10 includes a base 11, a plurality of mounting seats 13 disposed on the base 11, a cover 12, and a protective cover 14.

The plurality of distance measuring assemblies 20a are installed on the base 11. Specifically, each distance measuring assembly 20a is installed on the base 11 through a mounting seat 13. For the installation relationship between each distance measuring assembly 20a and the mounting seat 13, the structure of each mounting seat 13, etc., reference can be made to the description of the above embodiments. The difference being that the overall shape of the base 11 may be different. The base 11 may be formed with a plurality of sets of mounting structures matching the distance measuring assemblies 20a. The mounting structures may be, for example, a plurality of sets of positioning columns 113, a plurality of installation spaces 1122, a plurality of intermediate walls 110, a plurality of set of mounting protrusions 114, a plurality of receiving spaces 1124, etc. The plurality of installation spaces 1122 may communicate with each other, the plurality of receiving spaces 1124 may communicate with each other, and the plurality of intermediate walls 110 may communicate with each other.

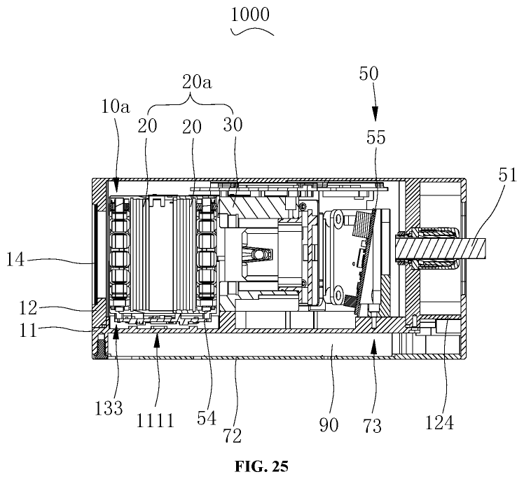

Referring to FIG. 25, the base 11 and the cover 12 are combined to form a receiving cavity 10a, and the plurality of distance measuring assemblies 20a are received in the receiving cavity 10a and installed on the base 11. Specifically, the base 11 and the cover 12 are combined to form a sealed receiving cavity 10a to prevent external dust, water vapor, etc. from entering the receiving cavity 10a, and noise generated by the operation of the distance measuring assemblies 20a may not easily emit outside from the receiving cavity 10a. The base 11 includes a bottom plate 111 and an annular limiting wall 112 extending from the bottom plate 111. The cover 12 includes a cover top wall 121 and an annular cover side wall 122 surrounding the cover top wall 121. The cover side wall 122 is installed on the bottom plate 111 and surrounds the limiting wall 112. The distance detection device 1000 also includes an annular sealing member 62. The annular sealing member 62 is disposed on the bottom plate 111 and surrounds the limiting wall 112, and the sealing member 62 is positioned between the cover side wall 122, the limiting wall 112, and the bottom plate 111. The sealing method of the base 11 and the cover 12 may be the same as described in the above embodiments, and the difference may be the outer contour of the base 11, the outer contour of the cover 12, the specific shape of the sealing member 62, and the like.

The cover 12 includes a cover side wall 122, and a light-transmitting area 1220 is formed on the cover side wall 122. The light-transmitting area 1220 can be used for passing the distance measurement signal sent by the distance measuring assembly 20a. The light-transmitting area 1220 may be an area made of a light-transmitting material on the cover side wall 122, and the light-transmitting area 1220 may also be a through hole formed on the cover side wall 122. The distance measurement signals (e.g., laser pulses) can pass through the light-transmitting area 1220 to penetrate into or out of the receiving cavity 10a. The area on the cover side wall 122 other than the light-transmitting area 1220 may be a non-light-transmitting area 1223, and the distance measurement signal may not pass through the non-light-transmissive area 1223, thereby preventing the signal entering from the non-light-transmissive area 1223 from being measured to interfere with the distance measuring assembly 20a.

More specifically, the cover side wall 122 includes a first cover side wall 1221 and a second cover side wall 1222. The first cover side wall 1221 and the second cover side wall 1222 are positioned at opposite ends of the cover top wall 121. When the distance measuring assembly 20a is installed in the receiving cavity 10a, the scanning module 20 can be close to the first cover side wall 1221, and the distance measuring module 30 can be close to the second cover side wall 1222.

The cover side wall 122 (the first cover side wall 1221) includes a plurality of cover sub-side walls 1224. Each cover sub-side wall 1224 can be formed with a light-transmitting area 1220, and each light-transmitting area 1220 can be used for the distance measurement signal sent by a corresponding distance measuring assembly 20a to pass through. In addition, the distance measurement signal penetrating through each light-transmitting area 1220 can also be received by a corresponding distance measuring assembly 20a. Each distance measuring assembly 20a may correspond to a specific light-transmitting area 1220, which can reduce mutual interference between the plurality of distance measuring assemblies 20a.

Referring to FIG. 20 and FIG. 23, in some embodiments, the two cover sub-side walls 1224 are connected in sequence. The cover sub-side walls 1224 may have the shape of a flat plate, and at least two cover sub-side walls 1224 can be in different planes. In the embodiments of the present disclosure, the plurality of cover sub-side walls 1224 are all in different planes, and the angle between two adjacent cover sub-side walls 1224 can be the same, such as 120°. In one example, the plane on which each cover sub-side wall 1224 is positioned can be perpendicular to the rotating shaft 2235 of the rotor 223a of the corresponding distance measuring assembly 20a. Since the light-transmitting area 1220 is formed on the cover sub-side wall 1224, the cover sub-side wall 1224 may have the shape of a flat plate. When the light-transmitting area 1220 is a part made of light-transmitting material on the cover sub-side wall 1224, the overall shape of the light-transmitting area 1220 can also be in the shape of a flat plate. The flat light-transmitting area 1220 has little effect on the propagation direction of the distance measurement signal and other parameters. For example, the flat light-transmitting area 1220 may not cause excessive refraction of the distance measurement signal. When the light-transmitting area 1220 is a through hole on the cover sub-side wall 1224, it may be more convenient to install a flat lens on the cover sub-side wall 1224 than to install the cover sub-side wall 1224 of a non-flat shape, such as an arc, and the flat lens can have less influence on the distance measurement signal.

In some embodiments, the plurality of cover sub-side walls 1224 may have a flat plate shape, and two adjacent cover sub-side walls 1224 may be connected by an arc-shaped sub-side wall. The arc-shaped sub-side walls can make the transition between the two adjacent cover sub-side walls 1224 relatively gentle, and the cover 12 may not be prone to stress concentration when subjected to a collision.

Referring to FIG. 23 to FIG. 25, the protective cover 14 is installed at the light-transmitting area 1220 of the cover 12, and the distance measurement signal (such as laser) can be emitted from the protective cover 14 to the outside of the housing 10. The base 11, the cover 12, and the protective cover 14 jointly form a sealed receiving cavity 10a. The protective cover 14 may be detachably or fixedly installed at the light-transmitting area 1220. At this time, the light-transmitting area 1220 may be a through hole. The laser pulse passing through the prism 23 can be emitted from the protective cover 14 to the outside of the housing 10, and the base 11, the cover 12, and the protective cover 14 together form a sealed receiving cavity 10a. At this time, the protective cover 14 may be made of materials with high light transmittance such as plastic, resin, and glass. When the protective cover 14 is detachably installed at the light-transmitting area 1220 of the cover 12, on one hand, it is convenient to replace the protective cover 14, and on the other hand, it is convenient to clean the protective cover 14, thereby preventing impurities accumulated in the light-transmitting area 1220 from affecting the optical path of the laser beam, and reducing the accuracy of distance detection.

The circuit board assembly 50 may have the same structure as the first electrical connector 52, the second electrical connector 53, and the electric adjustment board 54 of the circuit board assembly 50 in the above embodiments. The difference being the circuit board assembly 50 of this embodiment includes an adapter board 55 and a connector 51. The adapter board 55 can be installed in the housing 10. The adapter board 55 can be installed on the base 11, and the adapter board 55 can be electrically connected to the plurality of distance measuring assemblies 20a. Specifically, the connecting lines from the plurality of distance measuring assemblies 20a can be led to the adapter board 55 through the receiving space 1124. In this way, the plurality of distance measuring assemblies 20a can be connected through one adapter board 55, and there is no need to separately lead the lines of the distance measuring assemblies 20a from the housing 10. The adapter board 55 can be used to merge the distance measurement results of the distance measuring assemblies 20a and output it from the connector 51. Alternatively, the adapter board 55 can be used to output the distance measurement results of the plurality of distance measuring assemblies 20a from the connector 51 separately. The connector 51 can be connected to the adapter board 55 and can be used to connect an external device. At this time, the external device may be an external device that provides power or control signals for the distance measuring assemblies 20a.

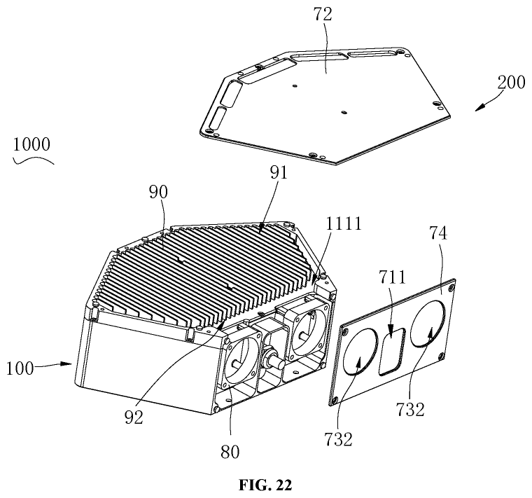

Referring to FIG. 22 to FIG. 24, the heat dissipation structure 200 includes a baffle assembly 70 and a fan 80. The baffle assembly 70 and the fan 80 can be disposed on the housing 10, and the baffle assembly 70 and the housing 10 together can form a heat dissipation air duct 73. The heat dissipation structure 200 may be formed with an air inlet 731 and an air outlet 732 connected to the heat dissipation air duct 73 and the outside of the distance detection device 1000. The fan 80 may be disposed in the heat dissipation air duct 73 and positioned at the air inlet 731 and/or the air outlet 732.

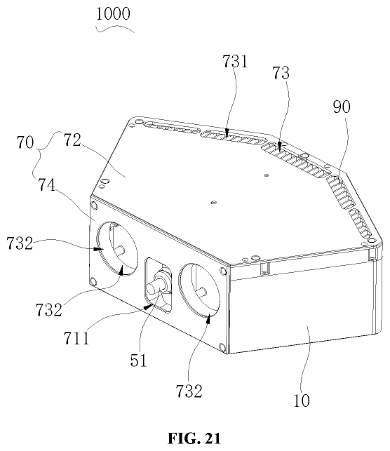

Specifically, referring to FIG. 20 and FIG. 21, the baffle assembly 70 includes a first baffle 72 and a second baffle 74. The first baffle 72 is disposed on the base 11, and the second baffle 74 is disposed on the cover side wall 122. The first baffle 72, the second baffle 74, the base 11, and the cover side wall 122 jointly enclose the heat dissipation air duct 73. An air inlet 731 is disposed at one end of the first baffle 72 away from the second baffle 74, an air outlet 732 is formed on the second baffle 74, and the fan 80 is installed at the air outlet 732. Specifically, the plurality of distance measuring assemblies 20a and the first baffle 72 are respectively disposed on opposite sides of the base 11, and the heat generated by the plurality of distance measuring assemblies 20a can be transferred to the heat dissipation air duct 73 through the base 11. The fan 80 may be an axial fan. The fan 80 can be used to establish an air flow entering form the air inlet 731, flowing through the heat dissipation air duct 73, and out of the air outlet 732. The air flow can take away the heat transferred by the base 11 to dissipate the plurality of distance measuring assemblies 20a. The air outlet 732 can be formed on the second baffle 74. The air inlet 731 can be disposed at one end of the first baffle 72 away from the second baffle 74, which extends the length of the heat dissipation air duct 73, and facilitates the airflow to fully exchange heat with the base 11 in the heat dissipation air duct 73.

The second baffle 74 can be disposed on the second cover side wall 1222. There may be two air outlets 732 and two fans 80, and the two fans 80 can be installed at the two air outlets 732 respectively. The two fans 80 can increase the air volume and wind speed flowing through the heat dissipation air duct 73, thereby quickly removing the heat in the heat dissipation air duct 73. A baffle hole 711 can be formed on the second baffle 74. The connector 51 can pass through the cover side wall 122 from the receiving cavity 10a. The end of the connector 51 away from the receiving cavity 10a can extend from the baffle hole 711 to the second baffle 74, and the other end of the connector 51 can be used to connect the distance measuring assembly 20a. Specifically, the two air outlet s732 can be positioned on both sides of the baffle hole 711 respectively.

Referring to FIG. 21 and FIG. 22, the heat dissipation structure 200 can further include a plurality of heat sinks 90 disposed on the base 11 at intervals. The plurality of heat sinks 90 can be housed in the heat dissipation air duct 73 and disposed on the air path from the air inlet 731 to the air outlet 732. The heat sink 90 includes a first surface 91 and a second surface 92 opposite to each other. The first surface 91 of each heat sink 90 can be attached to the first baffle 72, and the second surface 92 can be attached to the base bottom surface 1111.

When the heat dissipation structure 200 dissipates heat from the distance measuring device 100, the fan 80 can suck air from the air outlet 732, and the cold air from the outside can enter the heat dissipation air duct 73 from the air inlet 731. When the cold air passes through the heat dissipation air duct 73, it can take away the heat on the heat sink 90 and blow it out from the two air outlets 732, thereby taking away the heat from the base 11 and realizing the heat dissipation of the distance measuring device 100. Due to the additional heat sink 93, the heat concentrated on the base 11 can be transferred to the heat sink 93, thereby increasing the heat dissipation area. In addition, the heat sink 93 can be disposed in the heat dissipation air duct 73, such that the heat on the heat sink 93 can also follow the air flow quickly out of the air outlets 732 on both sides, which further improves the heat dissipation efficiency.

Referring to FIG. 22 and FIG. 23, the cover 12 also includes a partition 124 extending from the cover side wall 122 away from the receiving cavity 10a. When the second baffle 74 is disposed on the cover side wall 122, the partition 124 can surround the baffle hole 711 and can be attached to the second baffle 74. The partition 124 can separate the heat dissipation air duct 73 from the connector 51 and surround the baffle hole 711, and the partition 124 can be attached to the second baffle 74 to prevent airflow from entering the baffle hole 711 and affecting the normal operation of the connector 51.

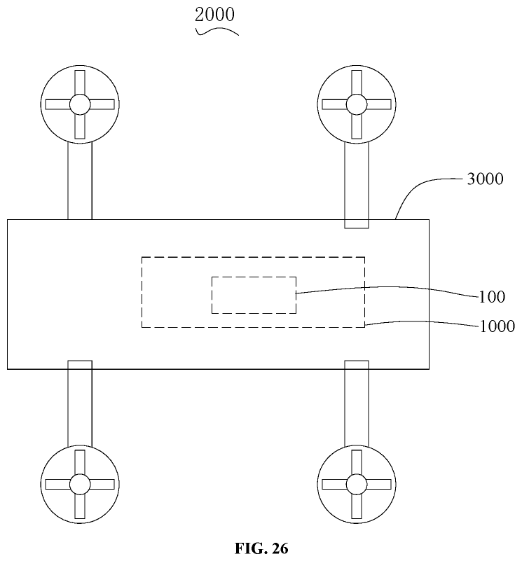

Referring to FIG. 26, an embodiment of the present disclosure further provides a mobile platform 2000. The mobile platform 2000 can include a mobile platform body 3000 and the distance detection device 1000 or the distance measuring device 100 of any of the above embodiments. The mobile platform 2000 may be a mobile platform 2000 such as an unmanned aerial vehicle, an unmanned vehicle, and an unmanned ship. A mobile platform 2000 may be equipped with one or more distance detection devices 1000; or, a mobile platform 2000 may be equipped with one or more distance measuring device 100. The distance detection device 1000 and the distance measuring device 100 can be used to detect the environment around the mobile platform 2000, such that the mobile platform 2000 can further perform obstacle avoidance and trajectory selection operations based on the surrounding environment.

In the present description, descriptions of reference terms such as “an embodiment,” “some embodiments,” “illustrative embodiment,” “example,” “specific example,” or “some examples,” mean that characteristics, structures, materials, or features described in relation to the embodiment or example are included in at least one embodiment or example of the present disclosure. In the present description, illustrative expression of the above terms does not necessarily mean the same embodiment or example. Further, specific characteristics, structures, materials, or features may be combined in one or multiple embodiments or examples in a suitable manner.

In the description of the present disclosure, it should be understood that the terms “first,”, “second,” etc. are only used to indicate different components, but do not indicate or imply the order, the relative importance, or the number of the components. Further, in the description of the present disclosure, unless otherwise specified, the term “first,” or “second” preceding a feature explicitly or implicitly indicates one or more of such feature.

Although the embodiments of the present disclosure have been shown and described above, it can be understood that the above embodiments are exemplary and should not be construed as limitations on the present disclosure. Those skilled in the art can change, modify, substitute, or vary the above embodiments within the scope of the present disclosure. The scope of the present disclosure is defined by the appended claims and their equivalents.

What is claimed is:

1. A distance detection device, comprising:
a housing; and
a plurality of distance measuring assemblies disposed in the housing, wherein:
two adjacent distance measuring assemblies have overlap field of views, and each distance measuring assembly is configured to measure a distance from an object to be detected in the corresponding field of view to the distance detection device.

2. The distance detection device of claim 1, wherein:
the plurality of distance measuring assemblies are radially disposed in the housing.

3. The distance detection device of claim 2, wherein:
an angle of central axes of any two adjacent distance measuring assemblies are equal.

4. The distance detection device of claim 1, wherein:
the angle of the central axes of two distance measuring assemblies is less than half of a sum of the angles of the field of views of the two distance measuring assemblies.

5. The distance detection device of claim 4, wherein:
the angle of the central axes of two distance measuring assemblies is less than 90% of the angle of the field of view of any one of the two adjacent distance measuring assemblies, or the angle of the central axes of two distance measuring assemblies is greater than 30% of the angle of the field of view of any one of the two adjacent distance measuring assemblies.

6. The distance detection device of claim 1, wherein:
the plurality of distance measuring assemblies have field of views of the same size.

7. The distance detection device of claim 1, wherein:
the housing includes a base and a plurality of mounting seats disposed on the base, and each of the distance measuring assembly is mounted on one of the mounting seats.

8. The distance detection device of claim 7, wherein the mounting seat includes:
a mounting plate fixedly connected to the base; and
a mounting arm extending from the mounting seat, the mounting plate and the mounting arm jointly forming a mounting groove, the distance measuring assembly being at least partially received in the mounting groove.

9. The distance detection device of claim 8, wherein:
a positioning column is formed on the base, and the mounting plate is fixedly connected to the positioning column to fix the mounting seat and the base.

10. The distance detection device of claim 7, wherein:
a mounting protrusion is formed on the base, and the distance measuring assembly is fixedly mounted on the mounting protrusion.

11. The distance detection device of claim 10, wherein:
the distance measuring assembly includes a distance measuring module, the distance measuring module including a distance measuring housing, the distance measuring housing being attached to the mounting protrusion and installed on the mounting protrusion to conduct heat of the distance measuring module to the base.

12. The distance detection device of claim 7, wherein:
the base is recessed to form a receiving space, the receiving space being used for routing one or more distance measuring assemblies.

13. The distance detection device of claim 7, wherein:
the base is recessed to form a receiving space, the receiving space separating the distance measuring assembly and the base, and a heat conducing element being disposed in the receiving space in contact with the distance measuring assembly and the base.

14. The distance detection device of claim 13, wherein:
the distance measuring assembly includes a scanning module, the scanning module being mounted on the mounting seat, and the heat conducing element being positioned between the scanning module and the base.

15. The distance detection device of claim 1, wherein:
the housing includes a base and a cover, the cover and the base jointly forming a receiving cavity, the plurality of distance measuring assemblies being received in the receiving cavity and mounted on the base.

16. The distance detection device of claim 15, wherein:
the cover is combined with the base to form a sealed receiving cavity.

17. The distance detection device of claim 15, wherein:
the cover includes a cover side wall, and a light-transmitting area is formed on the cover side wall.

18. The distance detection device of claim 17, wherein:
the housing includes a protective cover, the protective cover being mounted at the light-transmitting area of the cover for laser to emit from the protective cover to outside of the housing, the housing, the base, the cover, and the protective cover jointly forming a sealed receiving space.

19. The distance detection device of claim 17, wherein:
the cover side wall includes a plurality of cover sub-side walls, the light-transmitting area being formed on each of the cover sub-side walls, each light-transmitting area being used for a distance measurement signal sent by a corresponding distance measuring assembly to pass through.

20. The distance detection device of claim 19, wherein:
the plurality of cover sub-side walls are connected in sequence, the plurality of cover sub-side walls having substantially a flat plate shape, two or more cover sub-side walls being in different planes.

21. The distance detection device of claim 19, wherein:
the plurality of cover sub-side walls having substantially a flat plate shape, two adjacent cover sub-side walls being connected by an arc-shaped sub-side wall.

22. The distance detection device of claim 1, wherein:
the distance measuring assembly includes a distance measuring module and a scanning module, the distance measuring module being configured to emit laser pulses to the corresponding scanning module, the scanning module being configured to change a transmission direction of the laser pulses and project the laser pulses to the object to be detected, and receive the laser pulses reflected by the object to be detected and project the reflected laser pulse to the corresponding distance measuring module.

23. The distance detection device of claim 1, further comprising:
an adapter board and a connector, wherein:
the housing includes a base, the plurality of distance measuring assemblies being mounted on the base,
the adapter board is mounted in the housing and configured to electrically connect to the plurality of distance measuring assemblies, and
the connector is connected to the adapter board and configured to connect to an external device.
